(19) United States
(12) Patent Application Publication
(10) Pub. No.: US 2014/0040712 A1
(43) Pub. Date: Feb. 6, 2014

(54) SYSTEM FOR CREATING STORIES USING IMAGES, AND METHODS AND INTERFACES ASSOCIATED THEREWITH

(71) Applicant: Photobucket Corporation, Denver, CO (US)

(72) Inventors: Wayne C. Chang, Los Angeles, CA (US); Thomas A. Munro, Castle Rock, CO (US); Katharine A. Hare, Denver, CO (US)

(73) Assignee: Photobucket Corporation, Denver, CO (US)

(21) Appl. No.: 13/958,519

(22) Filed: Aug. 2, 2013

Related U.S. Application Data
(60) Provisional application No. 61/678,998, filed on Aug. 2, 2012.

(51) Int. Cl. G06F 17/21

(52) U.S. Cl. CPC G06F 17/212
USPC 715/202; 715/253; 715/252

(57) ABSTRACT

A system and method are provided for arranging photographs, drawings, videos and other media elements in a logical and visually appealing manner. Media elements may be selected, automatically or manually arranged in a progression to collectively tell a complete narrative. The arrangement for the progression may provide some direction but not limit the creator to sending single elements at a time, or using templates, pages, folders, or albums. Images may be intelligently placed and/or sized. When viewing the story, a viewer can advance through the media and understand the full story or perspective. A user may resize, move, delete or add images to enhance the story. The story may be shared with others, some or all of which may also collaborate to add or change the story progression to provide different perspectives or content.

### RELATED APPLICATIONS

This application claims the benefit of, and priority to, U.S. Patent Application Ser. No. 61/678,998 filed on Aug. 2, 2012, and titled “SYSTEM FOR CREATING STORIES USING IMAGES, AND METHODS AND INTERFACES ASSOCIATED THEREWITH,” which application is expressly incorporated herein by this reference in its entirety.

### BACKGROUND

1. Field of the Disclosure

Aspects of the present disclosure relate generally to the field of arranging and viewing images and other media. More particularly, aspects of the present disclosure relate to arranging a collection of media elements in a logical and stylistic presentation or progression. More particularly still, aspects of the present disclosure relate to automatically and/or manually arranging media to collectively tell a narrative using a progression of such media. Still further aspects of the present disclosure relate to sharing a story progression and/or collaborating with others in creation of the story progression.

2. Description of the Related Art

Various web-based photo sharing systems allow users to upload, share and print photographs or other pictures over the Internet. Such systems may provide users with various options for organizing the uploaded images. A common technique is to allow the creation of individual albums or folders, which may in turn also have other sub-albums or sub-folders. A user may choose what folders or albums to create, with each typically having a theme so as to allow related images to be found in the same album or folder.

Users may choose any number of different types of themes for their respective folders or albums. Example themes may be based on time periods (e.g., a year, month or day), events (e.g., a vacation, a holiday, a graduation, etc.), a person within a folder (e.g., a son, daughter, parent, etc.), another type of collection, or any combination of the foregoing. For instance, an album based on a wedding event may have the name “Amy's Wedding”. Images stored in such a folder may be those taken of the wedding celebration or the couple. A wedding may also include other events other than simply the activities on the wedding day. Accordingly, such an album may have various sub-albums. For instance, sub-albums may have titles such as: “Engagement,” “Dress Rehearsal,” Bachelorette Party,” or “Wedding Day.” The various photographs or other images related to the various events related to the wedding may then be stored in the main album, or in a corresponding sub-album.

In addition to storing photographs and other images in folders, some web-based photo sharing systems allow users to arrange images in other ways, such as by creating scrapbook style pages. Using these systems, a user may combine groups of related images into one or more “pages,” with each page having a chosen design and template. Different themes and/or styles may be available for use. For instance, continuing the example above, a user may select a “wedding” theme which includes background graphics related to a wedding. A user may also select a particular style template that includes one or more fonts, page layouts, image edge treatments, matting or background colors, and the like. Multiple pages may also be created and combined to create a virtual book in which a user can flip through different pages.

In each type of system, namely a folder/album-based system or a page-based system, the user or creator may give others the access to view the images. A user may, for instance, publish a scrapbook page (or collection of pages) so that others can view his or her collection. Similarly, a user may set access permissions for a particular folder or album to allow others to view images within the folder or album. In other embodiments, single images may be shared using social media (e.g., by a post or message on FACEBOOK®, TWITTER®, INSTAGRAM®, PINTREST®, etc.).

While multiple images and other media may be used to tell a story, folders, albums, and single posts do not generally allow a person who receives access to such media to view the whole story in a cohesive or efficient manner. Single images—whether accessed in a folder or from a social media site—can give only a single glimpse of a larger narrative. To get more information, the viewer must ask for more details or may be required to view multiple posts. If multiple views are lost, the viewer may lose interest and miss part of the story. Moreover, to participate in the story, a viewer may have to upload a single image or set of single images, and then hope the creator or other viewers can discern the relationship such images have to other images. True collaboration to create a full narrative is thus absent.

Consequently, what is needed are improved systems, interfaces, and methods for creating and sharing images or other media in a manner that allows a complete narrative to be created and captured in a single, logical progression, potentially by using a combination of different types of media. Further aspects may allow or facilitate collaboration to allow others to add to a story. Further still, aspects may be provided to create on a single digital canvas a narrative that captures the attention of a viewer and maintains contact over a larger period of time than for a single page or media element.

### SUMMARY

In accordance with aspects of the present disclosure, embodiments of methods, systems, software, computer-program products, and the like are described or would be understood and which relate to sharing and organizing of photographs. In particular, aspects of the present disclosure relate to creating, managing and sharing stories composed of multiple images or other media elements. The media elements can be combined in a cohesive and complete manner that captures a full narrative, and can display the passion or interest in that narrative in a single, digital canvas. Accordingly, a user need not piece together different pictures, text messages, videos, and the like on their own, but can instead view all the information in a collective story.

An aspect of creating and sharing stories in this manner is not only the ability to tell a whole story, but also to capture the attention of a viewer for an extended period of time. For instance, a news source may make a news broadcast and then hope that the information gets to the viewer. If, instead, a story progression is created—potentially with voiceover or audio—multiple images, audio, text, video, or other media elements may be conveniently provided to hold the viewer's attention. Contact with the viewer may be made over an extended period of time. Further still, the story may be interactive so that the news source can identify exactly what portions captured the viewer's interest (e.g., by tracking interaction, view time, etc.). In a similar way, a commercial or advertisement may create a story progression allowing a longer contact period to increase the likelihood of interesting the consumer. For instance, images, videos, text, or other media elements, or some combination of the foregoing, may be collected for a single product or company. They may be arranged into a story progression as described herein (e.g., potentially by aggregating media elements with particular tags—including hash tags—from INSTAGRAM, FACEBOOK, TWITTER, FLICKR, etc.). The story progression can then be made public or shared (e.g., by being embedded into a website, social media page, etc.). A branded story or advertisement may thus be created to allow a user to view multiple images, videos, text, or other media elements, and to maintain contact with the viewer over a period of time. Of course, stories may be created for other reasons, including purely as informative stories for family members or friends.

In a more broad sense, aspects of the present disclosure relate to creating, viewing, and editing a story using multiple media elements. The media elements may be used to tell the story in a logical and complete manner. According to one aspect, various media elements may be identified. An arrangement of the images may be determined automatically or manually, or using a combination of manual and automatic input. The identified images may then be arranged, sized, and ordered as outlined by the determined arrangement. In at least some embodiments, the arrangement is a continuous, fluid arrangement. Such an arrangement may position images in a mosaic-type, visual fashion, with mixed sizes, shapes and orientations, and may not be broken into discrete pages, folders, or albums; however, other embodiments may allow stories to include pages, folders, albums and the like.

Aspects of the present disclosure may include selecting images from a single source or from multiple sources. For instance, a person may store photographs, videos or other images on multiple devices. A system of the present disclosure can access all of the different devices to obtain images to be used to collectively tell a story. The story may be directional or linear in nature to logically progression from a start to an end. If other people are granted access to the story, they may view or comment on the story, or even collaborate with the creator in further developing the story. For instance, a collaborator may be able to move, resize or otherwise edit images in the story, and even add new images. Such changes may allow the story to include multiple perspectives and expanded content. Different chapters or related stories may also be provided to branch off a single story, or provide related information.

According to some embodiments disclosed herein, a method may be provided for creating a story from a collection of images and/or other media elements. An example story may be created by identifying media elements to be incorporated and generating the story progression. In generating the story progression, an arrangement of the elements may be determined. The elements may also be positioned according to the determined order and arrangement. The positioned elements may be continuous and tell a story as a story progression, which includes a visual arrangement of media elements from any source which, when put together, tells a holistic, cohesive story. According to some embodiments, the arrangement of images may be determined automatically. A story generation system may, for instance, create a story and include automation intelligence with curation abilities for arranging images based on any number of different factors (e.g., size, date/time, location, content, etc.)

Other methods of this disclosure relate to editing a story progression and/or collaborating in creating a story progression. In at least one aspect, a story progression with multiple elements may be accessed. The elements may be continuous and sequential to collectively make up a cohesive story. Information may be received to indicate that a particular element of the story should be added, removed, or have a new position or size. The change may also create undesired negative space, in which case the position or size of one or more other elements may also be changed to limit the negative space. Such changes to other elements may also perform automatically. In some embodiments, the changes may also be based on conflicting or overlapping images so as to reduce or eliminate such overlaps and conflicts.

Another method disclosed herein may allow two or more users to collaborate to create a story from multiple media elements. In such a method, some elements may be identified by one user for incorporation into a story progression. Example elements may include images (e.g., still or video), audio or text. Such elements may be arranged into a sequential arrangement that tells a story and forms a story progression. The arrangement may be produced upon request from one of the collaborating users. Another collaborating user may also provide input that is received and which requests changes to the story and the story progression. In response the story may be changed as requested to allow collaboration with the first user. Such changes may include adding new elements, re-sizing elements, re-positioning elements, deleting existing elements, or the like. Collaboration may occur in any number of ways, including using a browser to interface with a service provider, using a mobile application, sending an email, using a social media page, or the like.

In still another embodiment, a method may be provided for distributing a story and a story progression that includes a sequence of images or other elements. Distributing the story may include accessing a story progression created by one or more users. The created story can include a sequential and continuous arrangement of images that collectively tell a story, optionally by using text, audio or other elements. The story may then be distributed to third parties (e.g., other users, guest viewers, etc.). Such third parties can access the story to view and scroll through the sequential and continuous arrangement to view the story. Third parties may also collaborate or otherwise interact with the story. As an example, guest viewers may provide comments related to the story progression, or to a particular element or section thereof. Viewers may also provide other comments, such as by indicating they “like”, “dislike”, or otherwise have an opinion about a portion of the story progression.

Other aspects, as well as the features and advantages of various aspects, of the present disclosure will become apparent to those of ordinary skill in the art through consideration of the ensuing description, the accompanying drawings and the appended claims.

### BRIEF DESCRIPTION OF THE DRAWINGS

In order to describe the manner in which features and other aspects of the present disclosure can be obtained, a more particular description of certain subject matter will be rendered by reference to specific embodiments which are illustrated in the appended drawings. Understanding that these drawings depict only typical embodiments and are not therefore to be considered to be limiting in scope, nor drawn to scale for all embodiments, various embodiments will be described and explained with additional specificity and detail through the use of the accompanying drawings in which:

FIG. 1 is a schematic illustration of an example communication system which may be used for creating a story progression using one or more types of media, and allowing collaboration among different users in creating or editing the story progression, according to an embodiment of the present disclosure;

FIG. 2 is a schematic illustration of an example computing system which may be used in the communication system of FIG. 1, the example computing system being suitable for use as a client computing system for receiving user input or creating media, or as a server component which communicates with client systems, according to an embodiment of the present disclosure;

FIG. 3 illustrates an example method for creating a story progression using one or more media elements, according to an embodiment of the present disclosure;

FIGS. 4-13 illustrate example views of a user interface that may be used in creating or editing a story progression, according to an embodiment of the present disclosure;

FIGS. 14-22 illustrate another example embodiment of a user interface that may be used to create, modify, or share a story progression, or to collaborate with others in developing a story progression, according to another embodiment of the present disclosure; and

FIG. 23 illustrates an example method for modifying a story progression in response to the addition of, or changes in size or position of, one or more elements of a story progression, according to another embodiment of the present disclosure.

### DETAILED DESCRIPTION OF PREFERRED EMBODIMENTS

Systems, methods, devices, software and computer-program products according to the present disclosure may be configured for use in accessing, storing, arranging and sharing photographs, videos, drawings, text, or other media elements, as well as in creating story progressions developed using the media elements. Without limiting the scope of the present disclosure, media data processed using embodiments of the present disclosure may include still or video image data. Image data may be representative of digital photographs or videos taken using a digital camera, or which is scanned or otherwise converted to a digital form. Similarly, image data may include drawings, paintings, schematics, documents, or the like which are created in, or converted to, a digital format.

Some media elements, regardless of the particular type of media, may be related. Such elements may be related in date/time, location, event, subject matter, or another manner, or in some combination thereof. Related media may be provided to system used to create a narrative in the form of a story progression. The system may access media elements and automatically create a narrative in the form of a continuous and logical progression of the accessible images. Images may be automatically sized, positioned, cropped, or otherwise arranged to effectively represent a narrative of a single event or related events. A user may manually alter the created progression as desired by, for instance, changing the locations, sizes and orders of some or all media. Such changes may be made to emphasize or deemphasize particular elements in the story, or may be made for any other subjective reason important to a user creating the story, or a contributor editing the story.

As used herein, the term “story progression” is used to refer to a visual arrangement of media elements (e.g., still images, video images, audio, text, etc.) that are accessible from any source and which are put together in a manner that tells a holistic, cohesive narrative. Media elements within a story progression are spatially located relative to all other images in the story progression, rather than just with respect to images of a common page. A story progression may be created automatically and optionally manually altered thereafter, or may be manually created. Regardless of whether automated or manual creation is used, a resulting story progression may be saved to tell a story through pictures (including still and/or video images), text, or other media elements, or some combination thereof, and potentially distributed. Access to a story progression may also be provided in a way allowing contributions from others. Thus, the story progression may also be published or otherwise provided for access over an electronic communication network such as the Internet.

Other people or computing systems may be granted access to the story progression. Access may be limited to viewing of the story progression, or commenting on the story progression. Other access rights may include the ability to collaborate with the creator. Such collaborators may be able to add additional images and other information to more fully develop the story told by the story progression, to provide alternative perspectives, to move or delete content (e.g., their own content or the original creator's content), or to otherwise enhance the story progression. Contributions to a story progression may be done after creation and on a stored story progression. In other embodiments, contributions and collaboration may be performed real-time as multiple users use their distinct computing devices to add, remove, or otherwise include media elements for incorporation into a collaborative story progression.

Certain aspects of the systems described in this disclosure may be used for implementing an online service for creating, sharing, and editing groups of media elements (e.g., images) in a manner that tells a story, as described in more detail herein. As such, the system architecture for providing such a system will first be described, following by a detailed description of a system, methods and interfaces for creating, sharing and editing story progressions. From time to time, the term “image” may be used in reference to the system for creating a story progression. It should be appreciated, however, that such term is for convenience only, and that any so-called “image” may include a variety of types of images (e.g., photographs, videos, drawings, etc.). Further, the term “media element” may also be used herein. The term “media element” may include images of any type, as well as any other type of media, including, but not limited to, text, advertisements, presentations, or other types of media, or any combination of the foregoing.

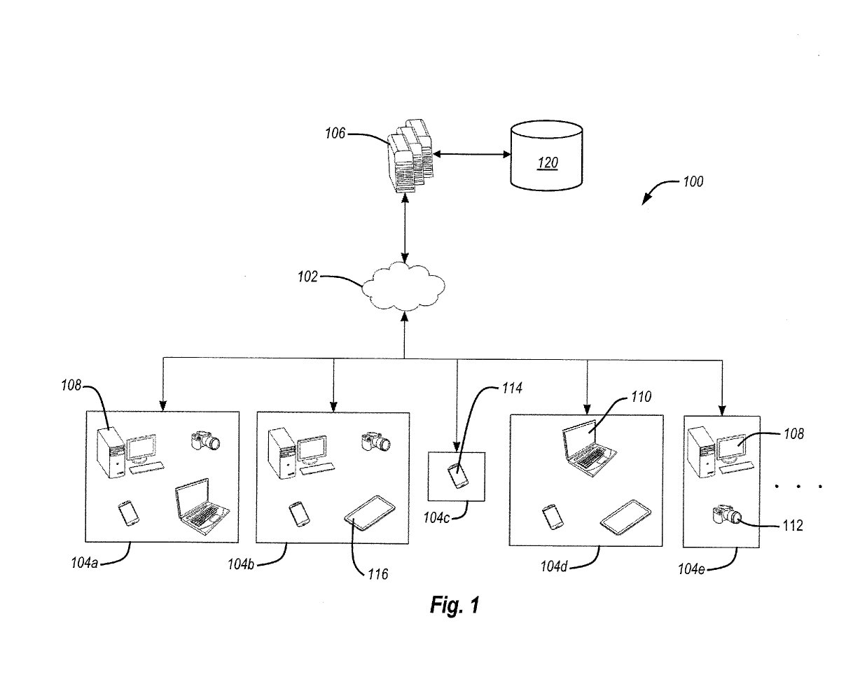

Turning now to FIG. 1, an example computing system 100 is shown and is representative of systems that may be used in connection with embodiments of the present disclosure for accessing, storing, and arranging images into story progressions, as well as for collaborating with others in the creation of story progressions. The illustrated system 100 is depicted as a distributed system.

The illustrated system 100 may operate using a network 102 facilitating communication between one or more end users 104a-104e and a server component 106. The end users 104a-104e may represent persons, businesses, or other entities that may have access to image data or other media elements, and which may want to share or publish the elements, or arrange the elements into a story progression.

The end-users 104a-104e may use any of various different types of end-user computing devices to interact with the server component 106. By way of example, the end-users 104a-104b may use traditional computing devices such as a desktop computer 108 or a laptop computer 110. As technology has advanced in recent years, other devices are also becoming increasingly powerful and may provide expanded computing capabilities. Accordingly, other computing devices that may be used by an end-user may include cameras 112, portable electronic devices 114 (e.g., mobile phones including so-called “smart phones”, personal digital assistances, personal media players, GPS units, watches, etc.), and tablet computing devices 116.

It should be appreciated in view of the disclosure herein that the end-user devices 108-116 are provided merely to illustrate that users may interact with a communication system using any number of different types of devices, and they are not intended to provide an exhaustive list of devices that may be used by an end-user 104a-104e. Indeed, examples of other suitable end-user devices may include land-line phones, netbooks, e-readers, two-way radio devices, other devices capable of communicating data over the network 102 or with another end-user device 108-116, or any combination of the foregoing.

In some embodiments, end-user devices 108-116 may communicate with the server component 106, or with other end-user devices 108-116 through the network 102. In other embodiments, out-of-band communications (not shown) may allow communications to bypass the network 102. In still other embodiments, an end-user device may not be capable of communicating with the network 102 or the server component 106. In such an embodiment, the end-user device may, however, be capable of communicating with another device (e.g., another end-user device of a particular end-user 104a-104e), which can then communicate with the network 102 and/or server component 106. For instance, the end-user 104e is illustrated as having access to a desktop computer 108 and a camera 112. While the camera 112 may include a communication interface capable of communicating directly with the network 102, the camera 112 may in other embodiments lack such a communication interface. Instead, a cable, memory card, or other communication interface may be provided to interface with the desktop computing device 108 which in turn may have a suitable communication interface for communicating with the server component 106, either directly or via the network 102.

An aspect of the various end-user computing devices 108-116 is that each may have the capability to store and/or generate data corresponding to media elements, as well as the ability to provide the data to one or more other components of the system 100. A camera 112, for instance, may be able to take still or video images. Such images may be stored on the camera's internal or removable storage media. Using the removable media, or a wired or wireless communication connection, or a combination thereof, the camera 112 can provide another computing device (e.g., another end-user device or the server component 106) with access to the stored images.

Of course, images or other media elements may be created or accessed by other end-user devices in similar manners. A desktop computer 108, laptop computer 110, portable electronic device 114, or tablet computing device 116 may access images stored on a camera (e.g., camera 112). Alternatively, such devices may have their own cameras so as to be able to generate images on their own, or have access to other peripheral devices (e.g., scanners) that can provide image data. Moreover, such devices are not limited to photographs or videos. For instance, an end-user device 108-116 may have software allowing a user to create a drawing, sketch, or other image, or to even edit an existing photograph or drawing. End-user devices 108-116 may also have the ability to create other media elements, including multimedia presentations, advertisements, text, sound effects or other audio data, or other media, or some combination of the foregoing.

In accordance with one aspect of the present disclosure, end-users 104a-104e provide data corresponding to one or more media elements to the server component 106, and the server component 106 may facilitate storage and/or sharing of the data. The server component 106 may comprise a single device or multiple devices to provide such functions. In FIG. 1, for instance, the server component 106 may include multiple servers and/or access to a data store 120. The data store 120 may be used to store raw data of the various images, or other media provided by an end-user 104a-104e. Information on the data store 120 may be accessed by the server component 106. In the same or other embodiments, the data store 120 may store processed data, including information related to the arrangement of media (e.g., story progression data as discussed in greater detail herein). The server component 106 may represent multiple servers or other computing elements either located together or distributed in a manner that facilitates operation of one or more aspects of the system 100. Additionally, while the optional storage 120 is shown as being separate from the server component 106 and the end-user or client devices 108-116, in other embodiments the storage 120 may be wholly or partially included within any other device, system or component.

In at least one embodiment, the network 102 may be capable of carrying electronic communications. The Internet, local area networks, wide area networks, virtual private networks (“VPN”), telephone networks, other communication networks or channels, or any combination of the forgoing may thus be represented by the network 102. Communication may be provided in any number of manners. For instance, messages that are exchanged may make use of Internet Protocol (“IP”) datagrams, Transmission Control Protocols (“TCP”), Hypertext Transfer Protocol (“HTTP”), Simple Mail Transfer Protocol (“SMTP”), Voice-Over-IP (“VOIP), land-line or plain old telephone system (”POTS″) services, or other communication protocols or systems, or any combination of the foregoing. Thus, the network 102, the end-user devices 108-116, the server component 106, and the data store 120, may each operate in a number of different manners, any or all of which may have communication capabilities to allow access and/or processing of image data consistent with the disclosure herein.

The system 100 is illustrative, but not limiting, of a media processing system that may be used to access any of a number of different types of media, to arrange media elements in a story progression, to share media elements or story progressions, to collaborate with others in creating story progressions, or for other purposes, or any combination of the foregoing. In one example embodiment, the system 100 may include the use of the end-user devices 108-116 to provide media elements to the server component 106. The server component 106 may include software, firmware, processing capabilities, or other features that allow the server component 106 to access the media elements and generate a story progression. In other embodiments, the end-user devices 108-116 may include the capabilities to generate a story progression. In such an embodiment, the server component 106 may be used to facilitate storage of the story progression, sharing of the story progression or media elements with others for either viewing or editing, access of template or intelligence information for arranging media elements, or other capabilities. Of course, a combination of the foregoing may also be provided so as to allow the end-user devices 108-116 and the server component 106 to each include some functions for cooperating to create a story progression.

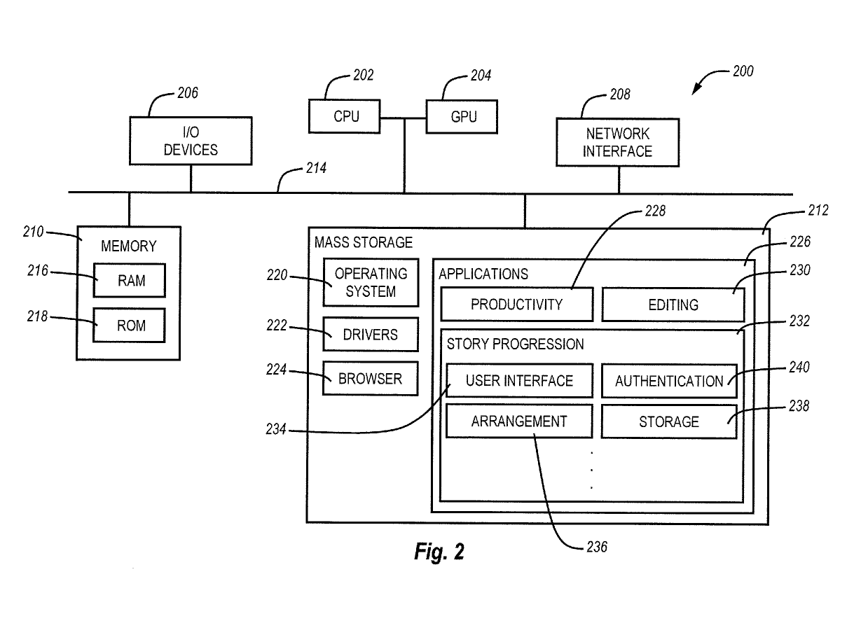

Turning now to FIG. 2, an example of a computing system 200 is illustrated and described in additional detail. The computing system 200 may generally represent an example of one or more of the devices, systems or components that may be used in the communication system 100 of FIG. 1. Thus, in some embodiments the computing system 200 may represent the server component 106, while in other embodiments the computing system 200 may represent an end-user device 108-116. In still other embodiments, the computing system 200 may be part of the network 102, or otherwise operate within the system 100.

In FIG. 2, the computing system 200 includes multiple components that may interact together over one or more communication channels. In this embodiment, for instance, the system 200 optionally includes multiple processing units. More particularly, the illustrated processing units include a central processing unit (CPU) 202 and a graphics processing unit (GPU) 204. The CPU 202 may generally be a multi-purpose processor for use in carrying out instructions of computer programs of the system 200, including basic arithmetical, logical, input/output (I/O) operations, or the like. In contrast, the GPU 204 may be primarily dedicated to processing of visual information. In one example embodiment, the GPU 204 may be dedicated primarily to building images intended to be output to one or more display devices that are part of, or otherwise connected to, the computing system 200. In other embodiments, a single processor or multiple different types of processors may be used other than, or in addition to, those illustrated in FIG. 2.

The CPU 202, GPU 204 or other processing components may interact or communicate with input/output (I/O) devices 206, a network interface 208, memory 210 and/or a mass storage device 212. One manner in which communication may occur is using a communication bus 214, although multiple communication busses or other communication channels, or any number of other types of component may be used. The CPU 202 and/or GPU 204 may generally include one or more processing components capable of executing computer-executable instructions received by, accessible to, or stored by the system 200. For instance, the CPU 202 or GPU 204 may communicate with the input/output devices 206 using the communication bus 214. The input/output devices 206 may include ports, keyboards, cameras, scanners, printers, display devices, touch screens, a mouse, microphones, speakers, sensors, other components, or any combination of the foregoing, at least some of which may provide input for processing by the CPU 202 or GPU 204, or be used to receive information output from the CPU 202 or GPU 204. In at least some embodiments, input devices of the I/O devices 206 may provide information in response to user input.

The network interface 208 may receive communications via a network (e.g., network 102 of FIG. 1). Received data may be transmitted over the bus 214 and processed in whole or in part by the CPU 202 or GPU 204. Alternatively, data processed by the CPU 202 or GPU 204 may be transmitted over the bus 214 to the network interface 208 for communication to another device or component over a network or other communication channel.

The system 200 may also include memory 210 and mass storage 212. In general, the memory 210 may include both persistent and non-persistent storage, and in the illustrated embodiment the memory 210 is shown as including random access memory 216 and read only memory 218. Other types of memory or storage may also be included in memory 210.

The mass storage 212 may generally be comprised of persistent storage in a number of different forms. Such forms may include a hard drive, flash-based storage, optical storage devices, magnetic storage devices, or other forms which are either permanently or removably coupled to the system 200, or in any combination of the foregoing. In some embodiments, an operating system 220 defining the general operating functions of the computing system 200, and which may be executed by the CPU 202, may be stored in the mass storage 212. Other example components stored in the mass storage 212 may include drivers 226, a browser 224 and application programs 226.

The term “drivers” is intended to broadly represent any number of programs, code, or other modules including Kernel extensions, extensions, libraries, or sockets, and generally represent programs or instructions that allow the computing system 200 to communicate with other components within or peripheral to the computing system 200. For instance, in an embodiment where the I/O devices 206 include a camera, the drivers 226 may store or access communication instructions indicating a manner in which data can be formatted to allow communication between the camera and the CPU 202. The browser 224 may be a program generally capable of interacting with the CPU 202 and/or GPU 204, as well as the network interface 208 to browse, view or interact with programs or applications on the computing system 200, or to access resources available from a remote source. Such a remote source may optionally be available through a network or other communication channel. Thus, when the computing system 200 is an end-user device, the browser 224 may communicate with a remote source such as a server component (e.g., server component 106 of FIG. 1). In contrast, when the computing system 200 is part of a server system, the browser 224 may interact with a remote source such as an end-user device (e.g., devices 108-116 of FIG. 1). A browser 224 may generally operate by receiving and interpreting pages of information, often with such pages including mark-up and/or scripting language code. In contrast, executable code instructions may generally be executed by the CPU 202 or GPU 204, and may be in a binary or other similar format understood primarily by processor components.

The application programs 226 may include other programs or applications that may be used in the operation of the computing system 200. Examples of application programs 226 may include productivity applications 228 such as email, calendar, word processing, database management, spreadsheet, desktop publishing, or other types of applications. The application programs 226 may also include editing programs 230. Editing programs 230 may be used for various functions. In one embodiment, an editing program 230 may be used to access, retrieve, or modify photographs, videos, drawings, audio data, advertisements, presentations, or other types of media elements. As will be appreciated by one of skill in the art in view of the disclosure herein, other types of applications 226 may provide other functions or capabilities.

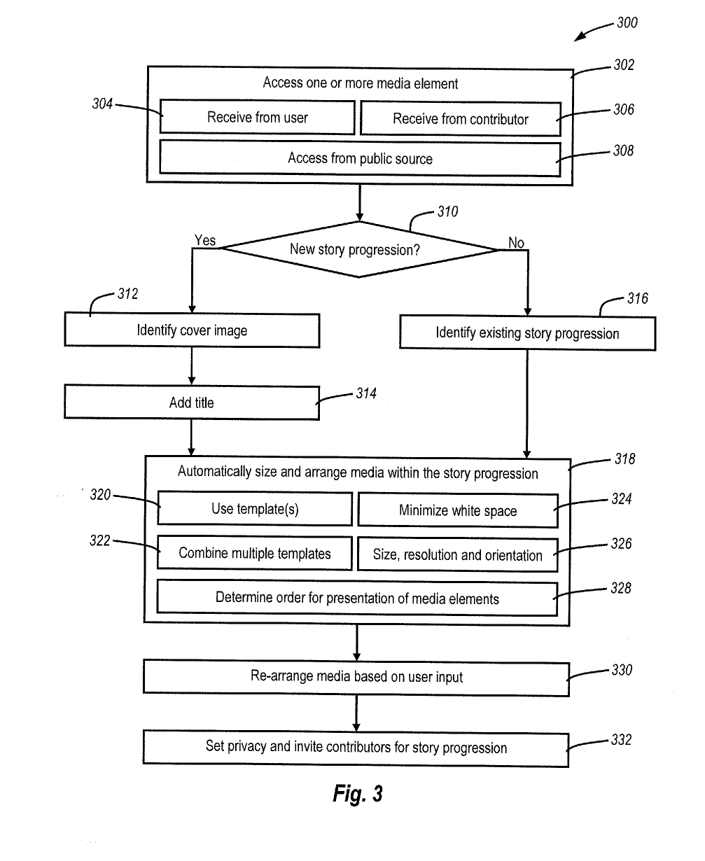

In at least one embodiment, the application programs 226 may include applications or modules capable of being used by the system 200 in connection with creating a story progression using multiple images or other media elements. An example story progression application 232 is shown in FIG. 2. For instance, in one example, various media elements available from one or more sources may be accessible to the story progression application 232. The story progression application 232 may use the media elements to generate a continuous and/or logical flow of media elements to in effect provide a narrative. FIGS. 3-23, and the discussion related thereto, provide some illustrative examples of manners in which a story progression application 232 may create, modify, share, or otherwise interact with a story progression.

In general, the story progression application 232 may provide a number of different functions, any or all of which may be controlled by a program module within the story progression application 232. For instance, as discussed herein, a story progression application 232 may allow the user to view a progression and/or interact with the application 232 to create, modify, or otherwise use the application 232. Accordingly, one embodiment contemplates a user interface module 234 that may facilitate interactions with a user and/or I/O devices of an end-user computing device. An example user interface module 234 may interact with a browser on an end-user device, thereby allowing the end-user to view, create, modify, or otherwise interact with the module through a browser, while a remote server or other device runs the application 232. Interaction may also occur in other manners. For instance, a mobile device may have a mobile application installed thereon, and the mobile application may locally perform some or all functions of the story progression application 232. In at least one embodiment, the example mobile application has the same or slightly enhanced capabilities relative to a general-purpose browser to allow a large portion of the application 232 to be executed remote from the mobile device. In still other embodiments, access to an application programming interface (API) for the application 232 may be provided to a third party, so as to allow private labeling or other customization of the interface and/or application.

Regardless of the particular manner in which the user interface module 234 and/or the application 232 function, and whether on a server, an end-user device, or a combination thereof, the story progression application 232 may access multiple media elements, including images, and arrange them into a progression of media elements. Such an arrangement may be performed using an arrangement module 236. The arrangement module 236 may include instructions determining how the system 200 can automatically or intelligently order and/or arrange the images or other elements within a digital canvas, or how to interact with a user who is manually creating or modifying a story progression.

As story progressions are created, they may also be saved. A story storage module 238 may be used to store the story progressions locally or remotely. Story progressions may also be the product of a collaborative effort or may otherwise be shared with other users. An authentication module 240 may manage the permissions associated with accessing a story progression and/or with accessing the story progression application 232. For instance, once a user creates a story progression, some third parties may be given access to view the progression, while others may be given access to add to the progression, while still others may be given full access to delete, add to, or otherwise edit the progression. In some cases, access permissions may allow only a single person access to edit a progression at one time, although in other embodiments a more collaborative system may even provide real-time or other access to allow multiple users, potentially at the same time. All of the permissions may be managed by the authentication module 240.

The modules 234-240 are merely some embodiments, and other modules may of course replace or supplement those illustrated in FIG. 2. For instance, an image creation or editing module may be provided to allow a user to edit images. A style module may be provided to further allow customization of text and fonts, backgrounds, music, media layouts, or other thematic elements.

The various components of the story progression application 232 may interact with other components of the computing system 200 in a number of different manners. In one embodiment, for instance, the computing system 200 may be part of a server component interacting with an end-user device. The end-user device may upload or otherwise provide access to media data through the network interface 208. The network interface 208 and bus 214 may provide the image data to the arrangement module 236 which can create a story progression. The story progression, or a representation thereof, can then be sent back to the end-user device (e.g., to a browser 220 of the end-user device, to a dedicated application of the end-user device, etc.) through the bus 214 and network interface 208. A story progression may also be sent via the bus 214 to one or more I/O devices 206, such as a display device. Different modules of the story progression application 232 may also be executed by one or more of the processors 202, 204. As an example, the CPU 202 may generally execute instructions to cause the arrangement module 236 to operate while the GPU 204 may optionally be used to interpret and/or display image data within media elements.

The system 200 of FIG. 2 is but one example of a suitable system that may be used as a client or end-user device, a server component, or a system within a communication or other computing network, in accordance with embodiments of the present disclosure. In other embodiments other types of systems, applications, I/O devices, communication components or the like may be included. Additionally, although a story progression application 232 is shown on a single system 200, such an application may be distributed among multiple devices or may execute using multiple, simultaneous instances of any or all of the modules 234-240.

FIG. 3 illustrates an example method 300 for accessing media elements, and arranging the media data into a story progression. The method 300 may, but need not necessarily, be performed by or within the systems of FIG. 1 or FIG. 2. In one embodiment, the method 300 is fully performed by a single computing system while receiving input or direction from a separate computing system. As an example, the method 300 may be performed using a server component that communicates over a network with an end-user device. A user of the end-user device may provide input which the end-user device sends to the server component to assist the server component in performing the method 300 of FIG. 3. In other embodiments, however, user input or other instructions may be received at the same device performing the method 300, or the method 300 may be performed in a distributed manner by different devices or systems.

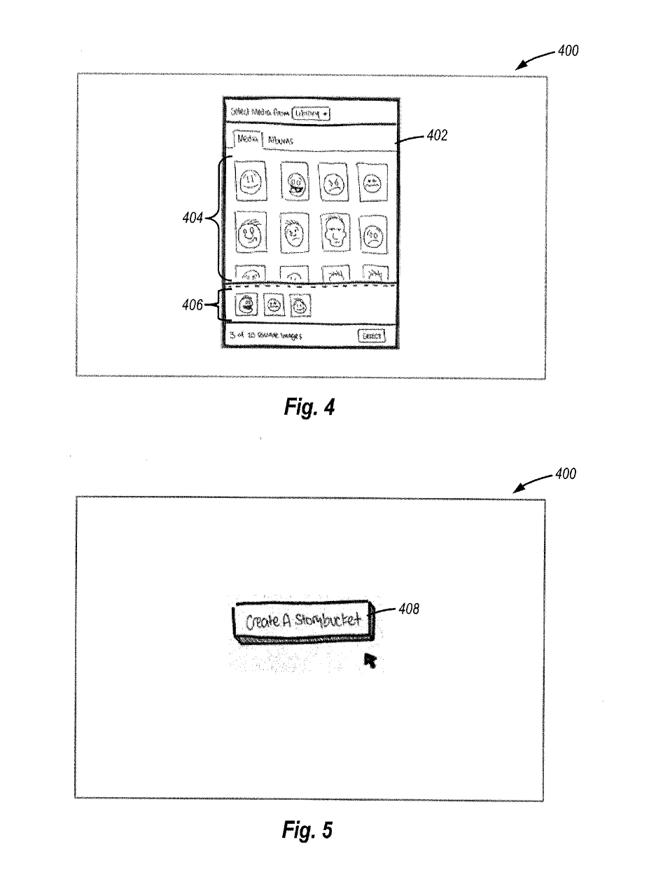

To assist in understanding an example manner in which the method 300 may be performed, FIGS. 4-13 illustrate various examples interfaces that may be displayed or used in a system while performing the method of FIG. 3.

The method 300 may begin by accessing one or more media elements (step 302), which elements may optionally include at least one image. Any of various manners may be used to access the media. For instance, media elements accessed in step 302 may be accessed when received or uploaded from a user (act 304). The user providing the media elements accessed in act 304 may be a creator of a story progression in some embodiments. In other embodiments, the media elements accessed may be from a third party. In FIG. 3, for instance, an act 306 may include receiving media elements from a contributor who may not be the original creator of a story progression. Of course, media elements may also be received or accessed in other manners, such as from a public source (act 308). As discussed in more detail herein, one manner of accessing or receiving media from a public source may include using social media to identify related media.

With reference now to FIG. 4, an example user interface 400 is illustrated and depicts one example manner for receiving images, and such embodiment may be used by the creator of a story progression in act 304 of method 300 in FIG. 3, or by a contributor in act 306. Such media elements may be accessed, identified, or received in any number of manners, and can include many different types of media. In one embodiment, for instance, the media may include one or more images identified in response to a user selecting one or more images, selecting a source for images, or the like.

More particularly, FIG. 4 illustrates the interface 400 as including a window 402. The window 402 may allow a user/contributor to select images or other media, select a folder or location of media, or the like. In this embodiment, a specified location includes a set of images 404 which may be selected. From the images 404, the user/contributor may select a subset of images 406. The subset of images 406 may be used in the method 300 of FIG. 3, although a user could select the entire image set 404, or the location where the image set 404 is located.

One aspect of the method 300 of FIG. 3 and the interface 400 of FIG. 4 is that selected images may come from any number of different sources. The creator of a story progression may, for instance, select a set of images stored on a desktop computer, while also or alternatively selecting images or other media stored by an online file management service, cloud-based storage service, or the like. Similarly, a contributor may select media stored within one or more folders or albums on a local computing device and/or on an online file management service. Images or other data stored by a desktop computer, laptop, mobile phone, digital camera, tablet computing device, cloud-based storage system, or the like may thus each be selected and accessible. Thus, media elements may be pulled or accessed from a variety of different locations and devices and provided to the server or another location in step 302.

With continued reference to FIG. 3, the method may also include determining whether media elements are to be included in a new story progression (act 310). As discussed in more detail herein, media elements may be added to a new progression that is being created, or they may be added to an existing story progression. FIG. 5 illustrates an example of the interface 400 for use in determining whether a new story progression is being created. In particular, the user interface 400 may display an input element 402 to allow a user to start the story progression creation process. In this embodiment, the input element 402 has the form of a button; however, the input element 402 may be replaced by other options, including links, commands, icons, menu items, or any combination of the foregoing. Although not shown in FIG. 3, a similar element may be used to allow a selection to edit an existing story progression. In some embodiments, the input element 402 in FIG. 5 may be displayed and/or selected following selection of media elements (e.g., in step 302 or using the window 402 of FIG. 4); however, other embodiments contemplate selection of the input element 402 prior to selection of media elements.

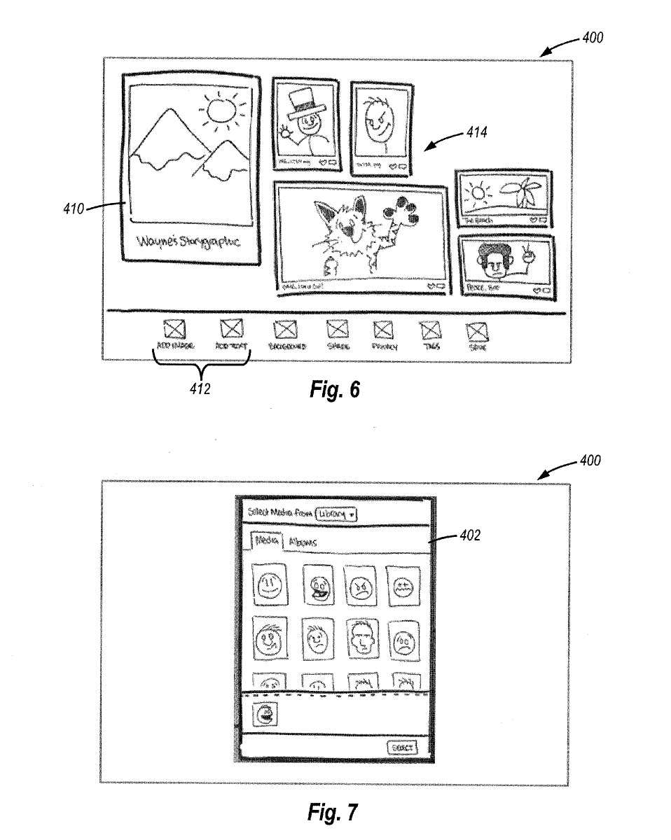

If the story progression is new, the method 300 of FIG. 3 may include additional acts, including identifying a particular media element to be used as a primary, or cover image (act 312). A title for the story progression may also be added (act 314). In some embodiments, the cover image may be a media element, or a representation of a media element, that acts similar to a title page and can be used as an introduction to convey a theme or topic of the story. The cover image may be displayed in a particular position, as a background, or may even remain visible at all times. In FIG. 6, for instance, the cover image 410 may be shown larger and/or first within a story progression. The cover image may also be used as an icon or symbol to represent the whole story progression in a list of story progressions (not shown).

The cover image and title may be added or selected in any number of manners. For instance, the cover image or title may be manually selected by a creator. A user interface (not shown) may therefore ask the creator of the story progression to select a cover image and/or a title. In other embodiments, a story progression creation system may automatically select a cover image in act 312. This may be done in a variety of manners, and may include selecting a media element based on the creation date, size, resolution, or other criteria, or a combination of the foregoing. For instance, as shown in FIG. 6, the interface 400 may display a story progression and the cover image 410 may be displayed larger than other media elements. A higher quality image may therefore be advantageous for use as the cover image.

As noted above, the title may be selected by a user in act 314, but may also be input in other manners. For instance, one embodiment contemplates selecting a set of media elements from a particular folder or album, in which case a title may be automatically identified as a name of the album or folder. In other embodiments, the story progression creation system may request a user provide login credentials to access the system. In such an embodiment, a default title including the user name of the creator may be used. Thus, a user name of “Wayne” may automatically have the title “Wayne's Storygraphic” added as a title as shown in FIG. 6. Of course, the title and/or cover image may also be editable so that a user can change any automatically set cover image or title. Acts 312 and 314 may thus be iterative and can be performed two or more times in the creation of a story progression using method 300.

In the event that media is being added to an existing story progression rather than a new story progression, the existing progression may be identified in act 316. The story progression can be identified in act 316 in any number of manners. For instance, a creator may share a story progression as discussed herein, and a collaborator may access and edit the story progression. The original creator may also access the story progression at a later time and then add new media elements. Public information may also be automatically identified and added. In some embodiments, a link to the existing story progression may be provided via email, a browser, or the like. Upon accessing the link, the user may access the story progression. In such an embodiment, the user may thereafter select media elements to add (e.g., using input elements 412). In other embodiments, after selecting media element to add, a user can select a story progression from a list in another manner. Indeed, FIG. 7 illustrates an example in which the window 402 may again be presented in the interface 400 to allow selection of additional media even after a story progression has initially been created.

Regardless of whether or not media elements are added to a new or an existing story progression, media elements accessed in step 302 may then be positioned within the story progression (step 318). Such positioning may be done by a computing system which automatically determines where to arrange media elements—including potentially where to insert one or more media elements into an already existing story progression. For instance, upon receipt of multiple media elements from the user in act 304 (e.g., after a user selects multiple media elements to include at a single time), a new story progression can be created by arranging the media elements into a story with a single click. In other embodiments, media elements may be manually positioned.

When media elements are automatically positioned in step 318, any number of considerations may be used to determine how to arrange and position the media elements. For instance, the computing system may use one or more templates (act 320). A template may generally define how media elements may be positioned on a digital canvas throughout the story progression. Templates used in act 320 may be strictly or loosely followed. Where followed strictly, an image that does not have the correct orientation/resolution may be cropped, rotated, or otherwise modified to fit within a predetermined area. In other embodiments, however, the template may be adjusted on the fly so that changes to the images or other media elements are unnecessary. For instance, an image may have a particular orientation and/or resolution, but loosely following the template may allow the image to be fit within an area of a template despite not strictly having the same size as an area specified by the template. As a more particularly example, a template may call for an image that is 400×300 pixels. If an image is accessed that is 650×540 pixels, to strictly fit within the template, the image may be resized and/or cropped to be 400×300 pixels. In contrast, a loosely followed template may allow resizing only of the image. For instance, the image may be resized to 361×300 pixels, which maintains the image's original aspect ratio while also fitting within the specified area of the template.

Additionally, because the number of media elements used in a story progression may vary from story to story, any template—whether loosely or strictly followed—may be dynamically based on the accessed media. Thus, if a template has too few spaces, multiple templates may be combined in act 322 to create a story progression having an extended length. In still other embodiments, if there are fewer media elements than spaces in a template, the template can be adjusted to remove extra spaces.

Still other embodiments contemplate additional or other mechanisms for automatically positioning media elements within step 318. For instance, automated processes may be used in some embodiments to minimize white or negative space within the digital canvas (act 324). In such an embodiment, rather than (or in addition to) using a template, a computing system may arrange media elements in a manner intended to limit the gaps or spaces between media elements. The individual characteristics of the media elements may be considered and media elements may be dynamically and intelligently positioned and arranged to provide visual interest as well as reduced white space. One manner in which this may be accomplished may include an act 326 of using size, resolution, orientation, or other characteristics of the media element. In such an embodiment, the characteristics of the media element themselves allow images to be intelligently arranged. In some embodiments, the arrangement may not be repetitive nor tied to any specific page, template, or pattern.

In addition to visually arranging images within a digital canvas, another aspect of arranging and sizing media within a story progression in step 318 may include determining an order for presenting the media elements (act 328). As discussed herein, determining the order may occur in any number of manners. For instance, media elements may be randomly presented based on a best fit to a template and/or to reduce white space. In other embodiments, however, such as where a logical progression of a narrative is desired, other or additional techniques may be used. In effect, a computing system may use one or more algorithms, calculations, intelligence modules, or other components, or any combination of the foregoing, to determine a logical or other suitable manner of presenting the identified media elements. Some embodiments may, for instance, use an arrangement module that accesses metadata associated with each of the identified media elements. As discussed herein, metadata relating to a size of the media element may be used in one embodiment to determine how to arrange media elements. For instance, if one image has a size of 200×300 pixels, while another has a size of 600×800 pixels, the arrangement module may automatically determine that the larger image should be more prominently be displayed, or should be preferred as a cover image or prior to the smaller image.

Other information may also be used by an arrangement module to determine the order for presenting media elements in act 328. For instance, if the selected media elements include photographs or videos, metadata associated with the image elements may include a time component. Using the time component, an arrangement module may generally arrange the images so that the story progression is chronological. Of course, other information may also be used in determining the arrangement, including what type of image file is accessed, metadata about the source of the image (e.g., a particular type of camera, geo-tagging information representing a particular location, etc.), image subject information (e.g., facial or other visual recognition to identify what or who is in the image), image source information (e.g., who is the contributor), display device capabilities, or image orientation. Media elements with similar time, location, content, contributor, or other components may be grouped together and presented before or after other media elements.

Once the media elements have been arranged, sized, and/or ordered in step 318, the story progression may be saved and/or displayed. In some embodiments, a creator or contributor viewing the story progression may make changes thereto. As shown in FIGS. 6-13, for instance, the story progression may include various media elements. More particularly, the illustrated embodiment in FIG. 6 shows six media elements that are currently displayed; however, upon scrolling to the right, additional media elements may be displayed. Such media may be displayed in a continuous manner so that a progression of media elements is provided, rather than a set of distinct pages, folders, albums, or the like. A creator or contributor may also wish to change the story progression by adding media elements. In other embodiments, additional or other changes may include removing media elements, re-positioning media elements, re-sizing media elements, and the like.

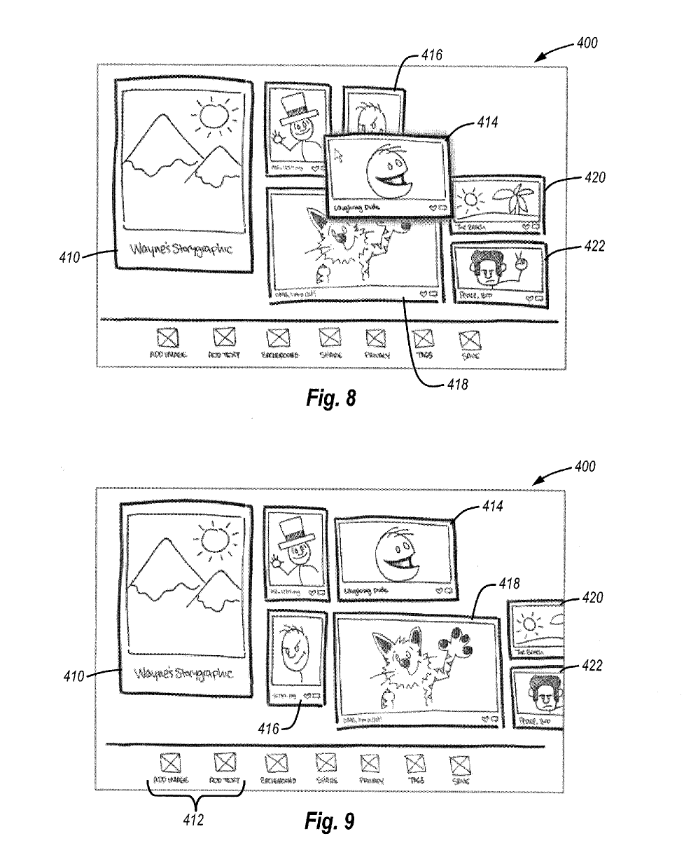

As a further illustration, the story progression of FIG. 6 may be altered by adding a media element (see FIG. 7). As then shown in FIG. 8, the newly added media element 414 may be inserted into story progression. In this particular example, the media element 414 may be manually moved to the desired position. For instance, the user could drop the image into a desired location (see FIG. 9). In other embodiments, the media element 414 could be automatically arranged within the story progression. The media element 414 can be automatically inserted at the end of a story progression, but other embodiments contemplate inserting and splicing the media element into the middle of the story progression as shown in FIG. 9. When splicing the story progression to add new media elements, an intelligence component may use similar or the same characteristics as used in step 318 to arrange and/or order images. Thus, a newly added media element 414 may be inserted or grouped with other elements having similar content, date/time information, location, or the like.

When a newly added media element 414 is added to the end of a story progression, there may be little or no effect to the other media elements within the story progression. In contrast, and as best shown when comparing the interface 400 of FIGS. 6 and 9, splicing a media element 414 into a story progression may interfere with other, already positioned media elements. Accordingly, the method 300 of FIG. 3 may include an act of re-arranging media (act 330). The act 330 may be in response to different types of user input (e.g., adding media, removing media, resizing media, moving media, re-positioning media, etc.). When such input occurs, different media elements may move and displace other media elements, which can in turn affect some or all later media elements within a story progression. More particularly, by inserting the new media element 414 at a location previously occupied by a media element 416, not only has the media element 416 moved, but also other nearby media elements 418-422 have also moved to accommodate the new location of media element 414 while preserving a visually pleasing, continuous narrative.

Of course, other input to re-arrange media elements, including adding additional media elements, removing media elements, resizing media elements, moving media elements, etc. may all cause multiple media elements of the story progression to be re-arranged in act 330. Re-arranging media elements may occur automatically (such as where a computing system automatically splices in a new media element), manually (e.g., by resizing a media element), or based on a combination of the foregoing (e.g., manually resizing or moving a media element may trigger an automatic response to move and/or resize other media elements).

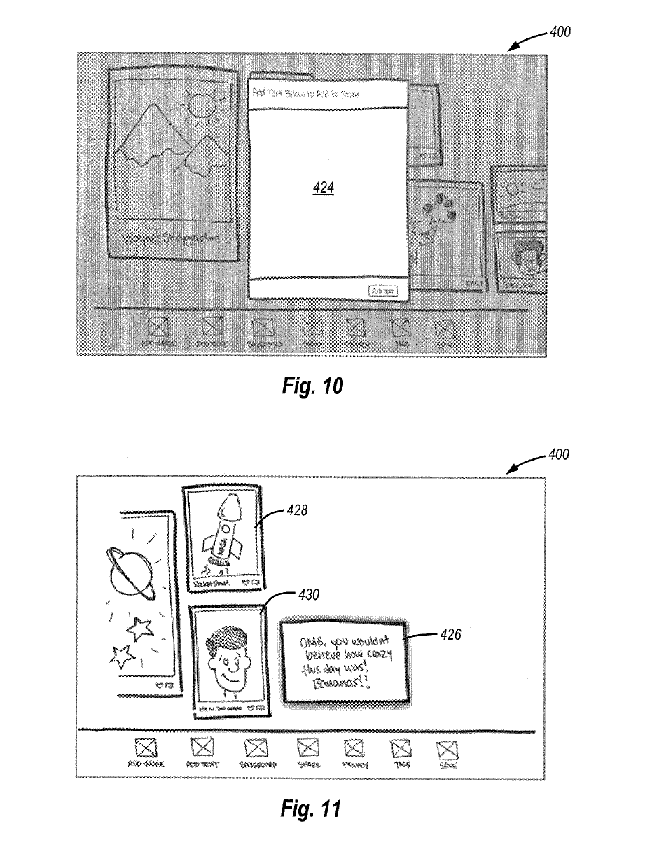

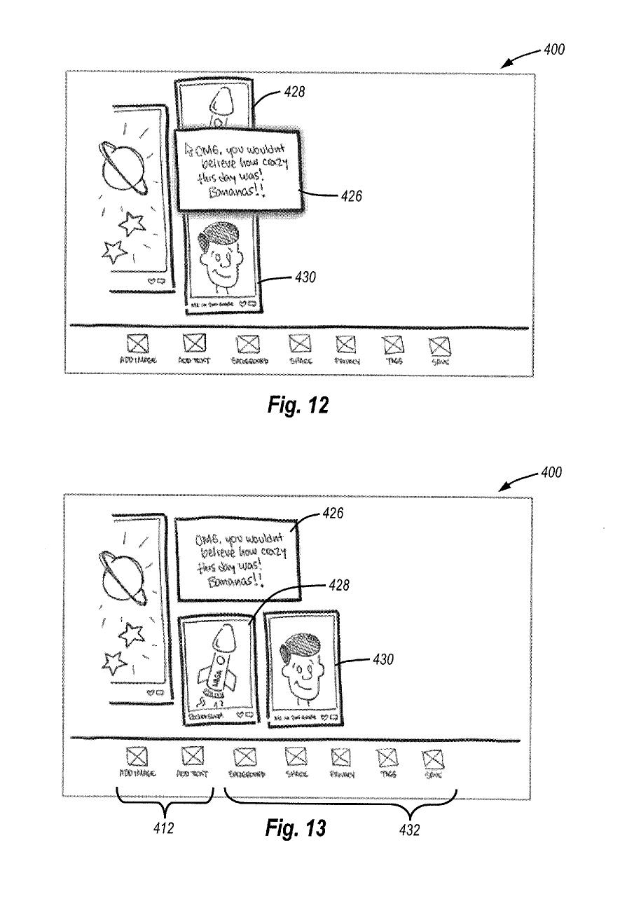

As discussed above, when original or new images are identified and added to a story progression, a determination may be made to automatically arrange the images. The foregoing is not, however, limited to use with photographs, drawings, videos, or other types of images. Indeed, a wide variety of media elements may be used in connection with embodiments of the present disclosure. FIG. 9 illustrates an example in which input elements 412 also allow text to be inserted. As then shown in FIGS. 10 and 11, a computing system may cause the interface 400 to then display a window 424 or other input area into which text may be added. The text added through the window 424 or other input area may then be automatically or manually arranged within the story progression as shown in FIG. 11. In FIG. 11, the text is shown as a media element 426 at the end of a story progression; however, the text may be otherwise located. In some embodiments, the text may be automatically or manually spliced into the story progression. FIGS. 12 and 13 illustrate an example in which the text element 426 may be re-arranged to move previously located media elements 428, 430 to new locations. The sizes, positions, and arrangements of the media elements 428, 430 may thus change to avoid collisions with the text media element 426. Of course, the text element 426 is merely illustrative of a variety of types of media elements, including audio elements, advertising elements, presentation elements, or other media elements, or some combination of the foregoing.

A user may save the story progression at any time. Various input elements 432, as shown in FIG. 13, may be provided to allow the story progression to be saved at any particular time, or to provide other actions. In FIG. 13, for instance, a “SAVE” option may be selected by a user, although auto-save options may also be implemented to allow recovery of a story progression.

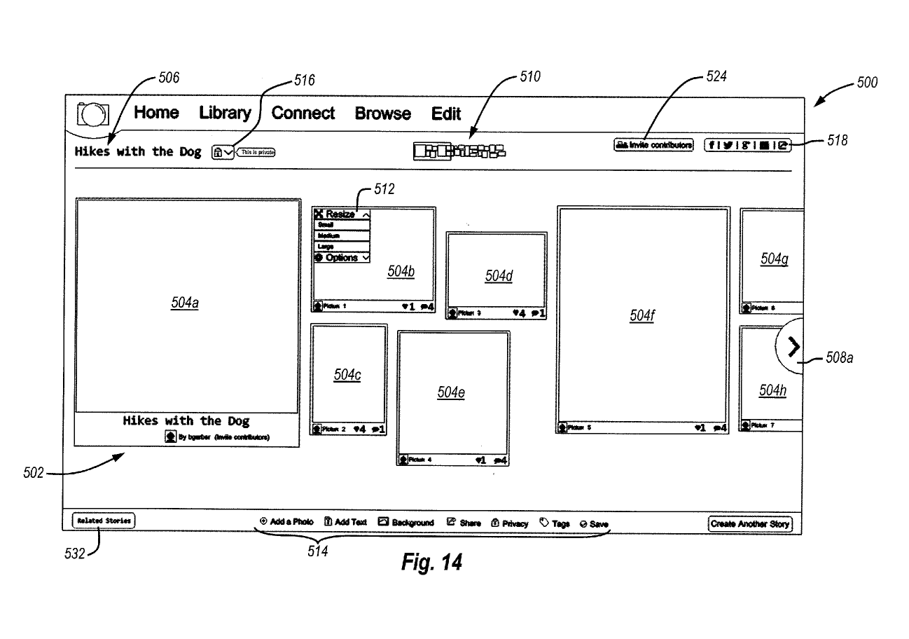

Other options shown in FIG. 13 may allow a user to customize the story progression. Example options may include options to add images or text (options 412). Other options may include options to add background images/audio, share the story progression, set/change privacy settings, or add tags to the story progression (options 432). Some examples of these options are described in greater detail with respect to the interfaces of FIGS. 14-22. Additional options may of course also be provided. For instance, an option to add audio may be provided. Added audio may include background sounds or music, voiceover audio (e.g., audio may update as a user scrolls through the story progression), and the like.

The method 300 of FIG. 3 may include any number of other or additional elements. As shown in FIG. 3, for instance, the method may further include an act 332 of setting privacy of the story progression and/or inviting contributors to collaborate on the story progression. Such an act may allow others to view and/or edit a story progression. FIGS. 14-22 below provide a description of some manners in which privacy and/or collaboration may be facilitated in accordance with some embodiments of the present disclosure.

Turning now to FIGS. 14-16, additional user interfaces 500 and methods are illustrated for arranging media elements in a story progression, according to additional embodiments of the present disclosure. It should be appreciated in view of the disclosure herein that these additional embodiments include elements that may be combined to, or may replace, elements described elsewhere herein.

FIG. 14 illustrates an example interface 500 that is similar to the interface 300 in FIG. 6. This example interface 500 illustrates an example embodiment in which a story progression 502 has already been created, and is now displayed. As described herein, the story progression 502 may include multiple elements 504a-504h, with such elements 504a-504h arranged in a linear progression, or in another manner. Such elements 504a-504h may have a logical and/or continuous progression that allows related images, text, video, and the like to convey a narrative.

The story progression 502 may not be limited to the elements 504a-504h shown in FIG. 14. For instance, additional elements, such as a title 506 may also be provided. In some embodiments, the title 506 may be repeated in multiple places. As an example, the title 506 is repeated in the interface 500 of FIG. 14 as a heading, and as a caption to element 504a. Although not necessary for all embodiments, the element 504a may be a primary or cover image automatically or manually selected for the story progression 502.

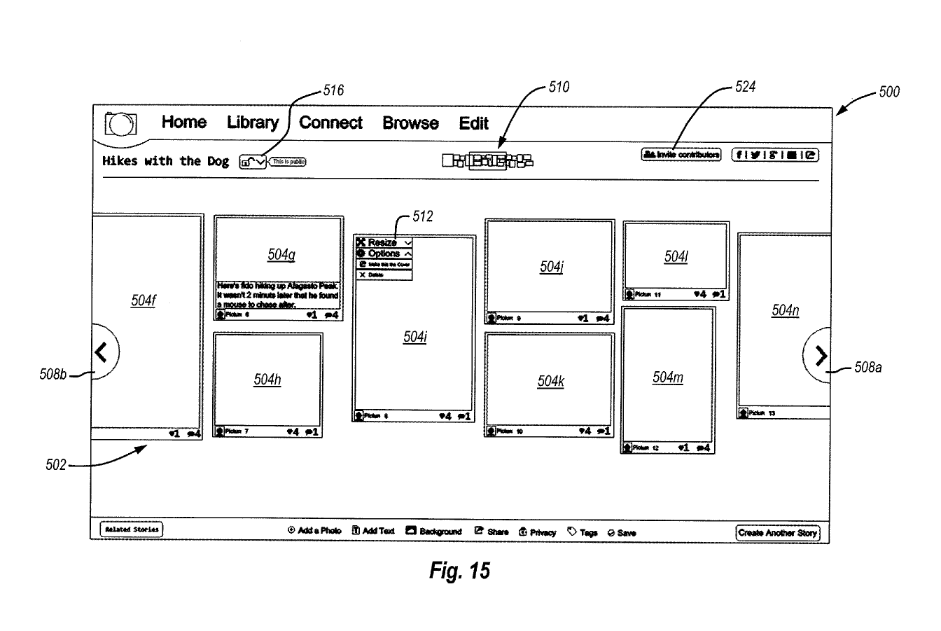

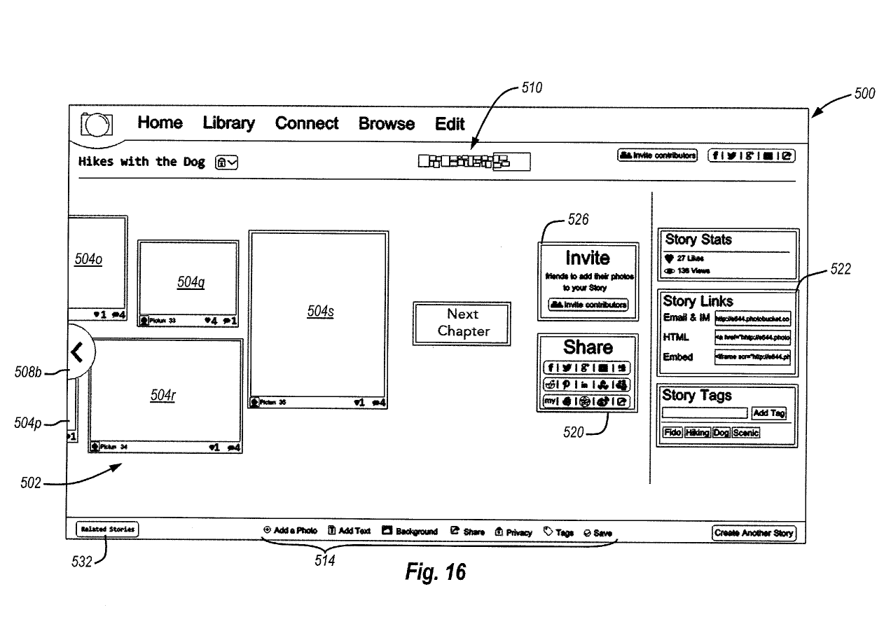

As also shown in FIG. 14, the interface 500 may include a scrolling function 508a. The scrolling function 508a is shown at the right side of the screen in this embodiment and, if selected by a user, may allow the user to scroll in a rightward direction to further view elements 504g and 504h, as well as potentially other images or other elements. For instance, FIG. 15 illustrates an example view of the interface 500 once scrolled. As shown in this figure, scrolling the story progression 502 may allow additional media elements (e.g., elements 504i-504n) to be displayed. The illustrated embodiments generally depict media element that may have any of a number of types, and may thus represent images, text, video, advertisements, presentations, audio, or the like. If still more media elements are available, the scrolling function 508a may also be displayed on the interface 500 in FIG. 15. FIG. 16 then illustrates the interface 500 once again scrolled one or more times using the function 508a, so as to display media elements 504o-504s. Additionally, as media elements may then also be available to the left of the displayed portion of the digital canvas, a second scrolling function 508b may also be provided to allow the user to scroll back, which is in FIGS. 15 and 16 at the left side of the interface 500.

With respect to the story progression 502 in FIGS. 14-16, it should be appreciated in view of the disclosure herein that the media elements 504a-504s may be arranged in any number of different manners, and that such arrangements may be produced through automated processes or manual processes as described herein. One aspect of some embodiments of this disclosure is that the arrangement of media elements is not based on discrete pages, nor on folders or albums. Instead, the media elements are accessible in a continuous progression that doesn't focus on any single media elements, nor on any particular page of arranged media elements. Rather, the arrangement may be based on the particular characteristics of each media elements. By using the characteristics of the media elements themselves, the media elements may be arranged in a manner that is not only not necessarily repetitive, but may also not be tied to any specific template or pattern, although in other embodiments, particular pages, templates, or the like may be used to arrange the media elements. As should be appreciated in view of the disclosure herein, in contrast to a page view in which the same media elements are collectively displayed together, the continuous progression allows a user to slide through the progression so that a media element may at times be displayed with one set of other media elements, and at other times with other media elements. Media element 504f of FIGS. 14 and 15 is an example as it can be displayed with media elements 504a-504h, or with media elements 504g-504n. Of course, depending on the location of media element 504f within the interface 500, the media element may also be displayed with other combinations of media elements.

A story progression may be rather long in some embodiments. To help a viewer navigate through the story progression, some embodiments contemplate a preview 510 that graphically illustrates the story progression 502, as well as the location of the viewer's focus within the story progression 502. As shown in FIGS. 14-16, for instance, the highlighted portion of the preview 510 may move as the user scrolls through the story progression.

The illustrated interface 500 may also provide a number of different features to customize, share, change or otherwise modify the story progression 502. For instance, a user may add text or audio to the story progression 502, or may even assign text or audio to a particular media element of the story progression 502. That information may then be displayed or played when the user or a third party views the story progression 502 and reaches the particular media element. In FIG. 15, a viewer may hover or select a particular media element (e.g., media element 504g). In doing so, the information assigned to the media element may be displayed as a caption or other description. Thus, information about the various media elements can be easily displayed or provided. Such information may be always displayed for a media element, or may be displayed only when selected, as described above. In some embodiments, such as those shown in FIGS. 14-16 some information may be permanently displayed while other information may be temporary. As an example, each of media elements 504b-504s may include a caption. Optionally, the caption provides information such as the name of the media element, an identification of who provided the media element, or the like. Such information is optionally always displayed. In contrast, the added text to media element 504g of FIG. 15 may be temporarily displayed when the media element 504g is selected or highlighted.

A user may also manually edit or rearrange the various media elements 504a-504s. FIG. 14 illustrates an example embodiment in which the user has selected an element 504b. When the interface is in an edit mode or the user has edit authorization for the story progression 502, selecting a media element may display one or more edit functions from an edit menu 512. In this embodiment, for instance, the menu may provide resize and other options. In the resize options, a user may be allowed to resize the image between small, medium, and large sizes. Such sizes may be automatically determined or constrained by the computing system providing the interface 500. In other embodiments, a user may be able to resize the media element 504b at any desired granularity, and potentially to even stretch or otherwise change the aspect ratio of the media element 504b.

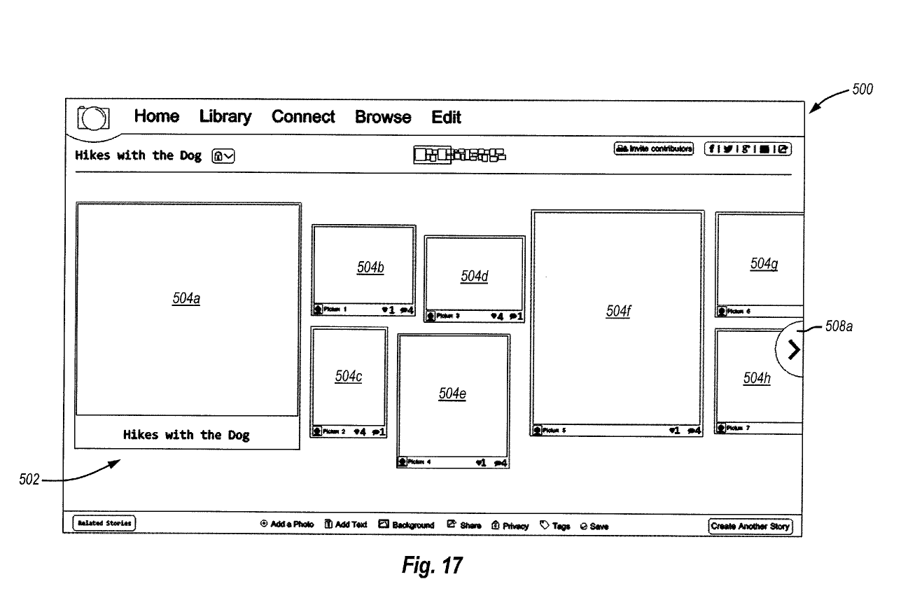

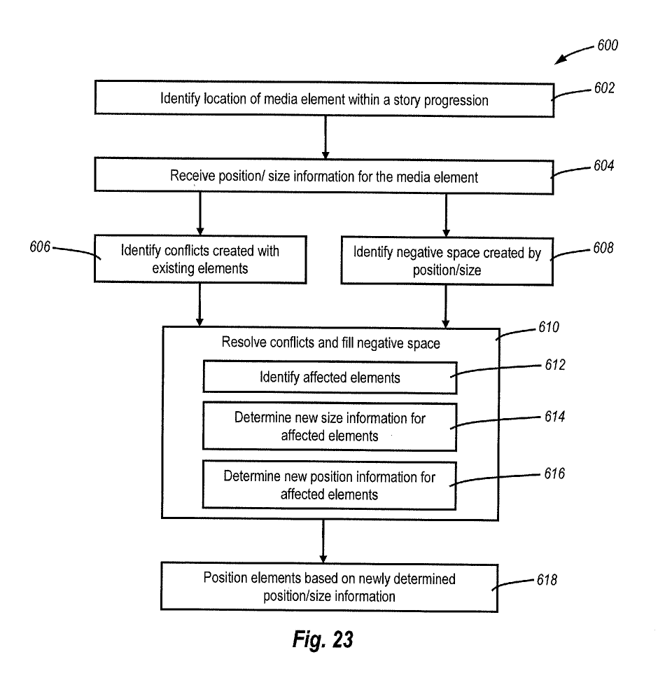

Resizing functions may be used to change the size of the media element 504b, without necessarily changing the media element's position. Selecting a small option may, for instance, allow a user to change from a larger version of the media element to a smaller version. FIG. 17 illustrates an example in which the size of media element 504b has been reduced. As also shown when the size of the element 504b is reduced, one or more of the elements 504c-504h may also be altered or re-arranged. In this embodiment, the elements 504d and 504f-504h have all shifted in a leftward direction when the size of image 504b is reduced. Such movement may be performed or determined by the system automatically. One such manner in which the movement may be determined is by determining that the change in size may create additional negative space, or white space, and then attempting to reduce the negative space. FIG. 23 provides an additional method that may be used to adjust the positioning of one or more media elements in such a scenario.

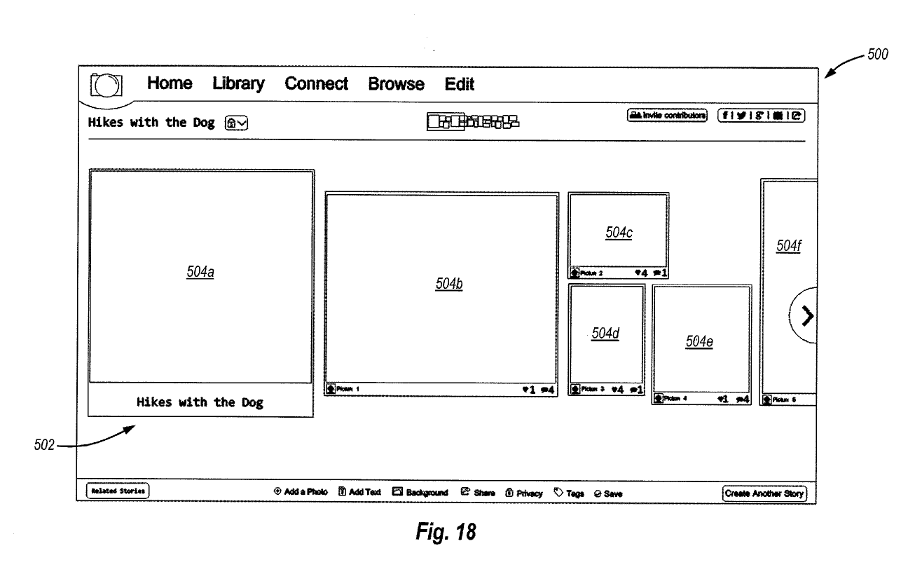

Instead of reducing the size of the media element 504b, the media element 504b may instead be enlarged. In the interface 500 of FIG. 18, a similar but opposite function may be performed by again selecting the media element 504b. A sizing function from the edit menu 512 of FIG. 14 may be used to enlarge the media element 504b. Consequently, media elements 504c-504f are shown as being moved to the right to accommodate the enlarged media element 504b. Of course, other embodiments may use a resize function to return a media element 504b to the original size shown in FIG. 14.

In some embodiments, a story progression application or system may identify a set of two or more predetermined sizes available for an image (e.g., small, medium, large, etc.). Thus, instead of being able to select any possible size (or any size within a range), only predetermined sizes may be available. In other embodiments, a user may be able to size the image to any desired size. Where predetermined sizes are generated, there may be between two or three predetermined sizes. In other embodiments, however, there may be more than three predetermined sizes, or even fewer than two predetermined sizes. For instance, some images may be fixed to allow only a single size. As an example, a cover image 504a may potentially be of a fixed size that cannot be changed while the image remains the primary or cover image. In other embodiments, every media element may be changed between different sizes.

Other options may also be provided. As shown in FIG. 15, for instance, the edit menu 512 may have expanded the other options. In this embodiment, the other options may allow a user to cause the selected media element 504i to become the new cover image. When a new cover image is selected, the selected media element (e.g., media element 504i) may be removed from its current location of the story progression and then moved to the first position as shown in FIG. 14. The media element corresponding to the prior cover image may then be automatically re-inserted at a logical position within the story progression 502.

As an additional option, the user may be allowed to delete the media element 504i from the story progression 502. To delete the media element 504i, the system optionally requires that the user have authorization to do so. Various levels of authorization may be provided as discussed herein. If the user does not have authorization to delete a media element, the delete function may not be provided, an error may be displayed indicating that the user does not have authorization to perform the delete function, or the option may simply be grayed out.

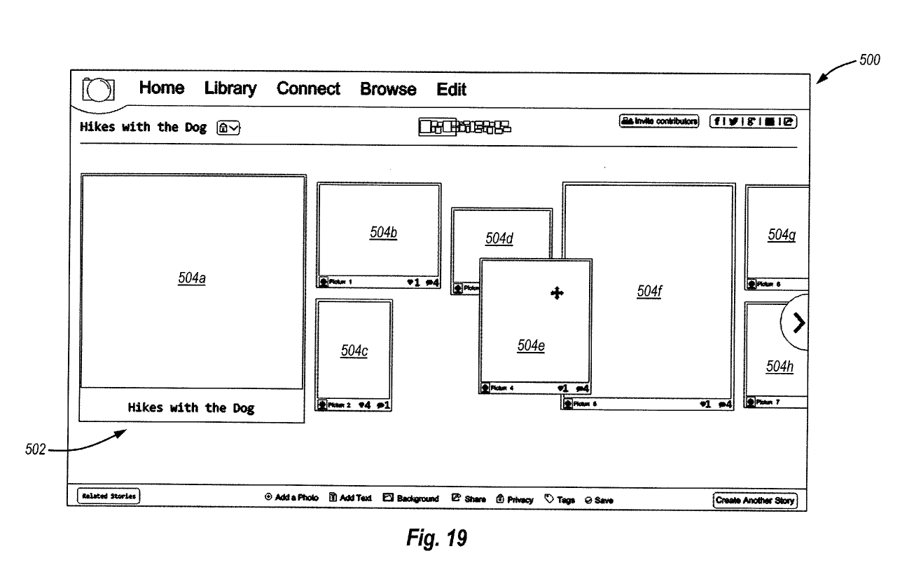

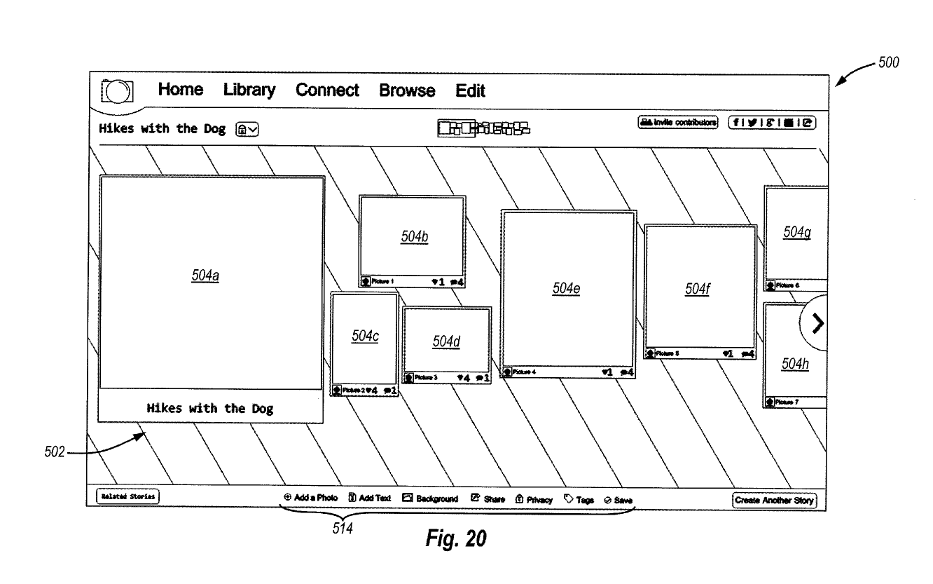

Changing the sizes of the media elements 504a-504s, changing cover images, or deleting media elements 504a-504s are only some of the aspect of a story progression interface 500 according to the present disclosure. In some embodiments, for instance, a user may change the position of one or more of the media elements. FIGS. 19 and 20 provide an illustration of an example in which a media element is moved.

As shown in FIG. 19, a user may select a media element to be moved. In this case, the media element 504e may be selected, and the user may begin dragging the media element 504e to a desired location. Upon reaching the desired location, the user may stop dragging and release the media element 504e. The media element 504e may then be placed at the indicated location. In some embodiments, the exact location where it was moved to may be used. In other embodiments, however, the system for managing story progressions may place it in an approximate location.

More particularly, media elements may be moved and “snap” into approximate locations. Such approximate cases may be determined as the story progression creation system monitors positions of other media elements and attempts to fit all media elements together in a mosaic or other pattern while also minimizing negative or white space. When a media element is moved, the story progression system may therefore evaluate repositioning and/or resizing of some or all other images in the story progression. FIG. 23 illustrates an example method 600 for modifying the story progression based on changes to the size or location of a particular media element.

As shown in FIG. 23, when a story progression is created or modified, the computing system executing a story progression application may assign or identify size and/or position information for an element of the story progression (act 602). In some cases, the size and/or position information may change, and new position or size information may be received for a media element (act 604). Such new position or size may create a conflict with other media elements (e.g., when moved to a location occupied by another media element). In other cases, moving an element may create a blank or negative space that could be fully or partially filled in some way. In some cases, conflicting positions and negative space may be created at the same time.

Accordingly, the method 600 of FIG. 6 may include acts of identifying the conflicts created (act 606) and identifying negative space created or increased by the received position and/or size information (act 608). In response, the method 600 may perform a step for resolving conflicts and/or filling negative space (step 610).

The system may perform any number of acts to resolve conflicts or fill negative space in step 610. This many include, among other things, identifying elements of the story progression that may be directly affected by the received size and/or position information (act 612). For instance, if an element is moved to a position occupied by another image, both the moved image and the underlying image may be identified as affected in act 612. In other embodiments, immediately adjacent or other nearby images may also be identified as potentially affected.

Once the affected elements are identified, they may be moved or otherwise modified to allow the story progression to present a fluid story. As shown in FIG. 6, this may include determining new size information for affected elements (act 614). Such size information may be determined for only the element which is initially moved. Thus, when an element is moved or resized, the change may only affect the positions of other elements, but not their size. In other embodiments, however, new size information for other elements may also be determined (e.g., elements with conflicting positions or other nearby elements that may be used to fill or minimize negative space).

In some embodiments, resolving conflicts and/or filling negative space may also include determining a new position for elements determined to be affected by changed size and/or position information (act 616). This many include, for instance, shifting some images to the left, right, up or down, or any combination thereof. As one element is moved to the right, for instance, one or more other elements may move to the left to provide space for the new element. Based on the manner in which conflicts and negative space are combated, the element for which new size or position information is received may be positioned, as may any or all other elements in the story progression (act 618). In some embodiments, repositioning or resizing one element may directly affect no other elements, or only one other element. In still other embodiments, however, one or more subsequent media elements may be affected, and potentially all subsequent media elements may be affected.

As an example, consider the interface 500 of FIGS. 19 and 20. When the image 504e is moved, a conflict with the image 504f may be created, as may negative space in the location previously occupied by image 504e. To account for such changes, the story progression application driving the interface 500 may move at least the images 504b, 504d and 504f, and potentially re-size them as well. In particular, FIG. 20 illustrates that each of images 504b, 504d and 504f has been re-positioned and re-sized. Thus, both prior and subsequent media elements may be affected. In other embodiments, however, a change in position may be made without re-sizing other elements. In such an embodiment, it may also be likely that other elements (e.g., images 504g, 504h) may be moved to the left or right to accommodate newly located elements.

The foregoing description provides only some aspects of a story progression interface 500, system, or application. Still other embodiments may include other components or elements. As shown in FIG. 20, for instance, the interface 500 may include a series of one or more options 514 for further customizing a story progression 502 and/or for allowing collaboration with others. Such options may include options to add an image, audio, text, or other media, which options have been previously discussed herein. In still other embodiments, a background may be selected. Upon selecting an option for a background, a user may be presented with an interface allowing a style, theme, image, or other background to be used. Such background may then be applied to the area behind the story progression 502. In FIG. 20, for instance, a background that includes diagonal lines may have been selected and added to the digital canvas.

Other options may include collaborating with others by sharing the story progression with them and/or setting privacy or access privileges to allow them access to edit the story progression. As shown in FIGS. 14-20, various mechanisms may be used to share a story or allow collaboration. FIG. 14, for instance, illustrates a privacy setting 516 illustratively placed near the title 506. By selecting different options (see FIG. 15), a user can make a story progression public or private.

As also shown in FIG. 14, a user may be presented various options to share the story progression 502. In this particular embodiment, sharing functions 518 are provided. In general, such options may be connected to email, social media, social news, blogging, or other websites that allow a story progression to be shared. For instance, the sharing functions 518 may include an option for email, FACEBOOK, TWITTER, GOOGLE+, REDDIT, PINTEREST, LINKEDIN, STUMBLEUPON, DIGG, QZONE, SINA WEIBO, BEBO, or other similar services or providers. Upon selecting one or more of the available options, the story progression 502 may be uploaded to such a service and shared with others, a link may be provided to be shared with others, or the story progression 502 may be otherwise shared. A “Share” option in the option list 514 may also be used to provide a similar function. As also shown in FIG. 16, the end of the story progression 502 may also optionally provide still other share options 520. Links 522 may also be provided to allow a user to easily email, embed, or otherwise reference the story progression.

In some embodiments, if the story progression 502 is public, others may view and potentially edit the story progression 502. Indeed, potentially anyone may access the story progression 50. In other embodiments, such as where the story progression 502 is marked as private, limited numbers of people may access and/or edit the story progression 502. In at least some embodiments, the interface 500 may include options to invite others to collaborate (see options 524, 526 of FIG. 16). Optionally, a security, privacy or other similar option in the option list 514 may also provide the ability to invite collaborators.

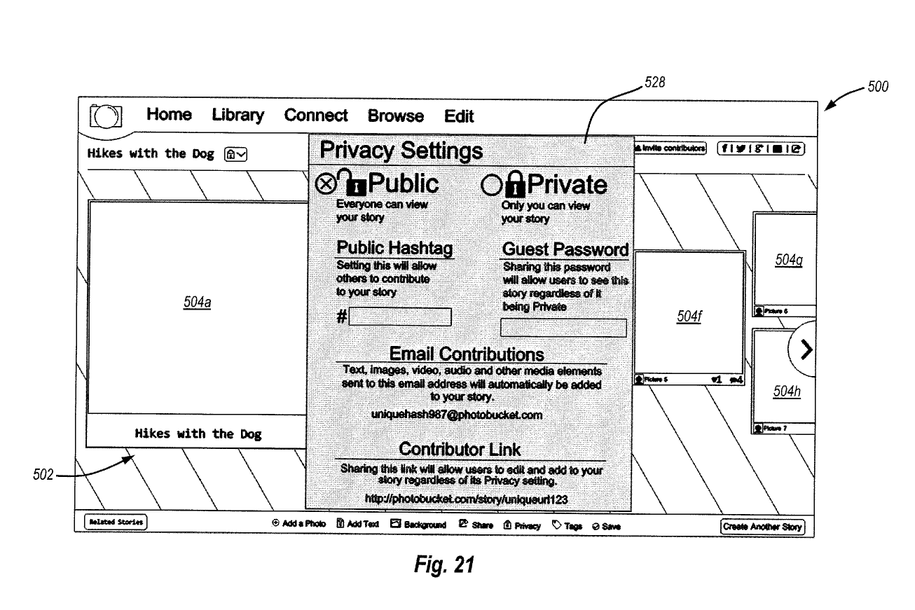

For instance, by selecting an option to view or create “privacy” settings in the interface 500, a privacy window 528 may be displayed as shown in FIG. 21. Using the privacy window 528, the user can determine whether or not others can view the story, and potentially to what extent others may view, edit, or otherwise contribute to the story.

In this particular example, for instance, a user is presented with various options for sharing the story progression. As one option, users who create a story progression may allow the story progression to be public so that it can be seen by anyone, or it may be private. When private, the creator may be the only person who can view the story. Alternatively, a private story may allow access to others selected by the creator. For instance, an option in the window 528 allows the setting of a password. Anyone with the password may be able to access the story, even if the story is marked as private.

The collaboration aspect may also be open to anyone or may be limited to certain people. FIG. 21 shows, for instance, in the window 528 that a user can set a public hash tag, although a keyword or other type of indicator may be used. In the case of a hash tag, the hash tag may include a tag or keyword within a message and prefixed by the hash sign (#). When a hash tag is used (e.g., in a message included with text or a picture posted through the TWITTER®, INSTAGRAM®, or other similar messaging service), the associated message, picture, video or other information can be added to the story progression. For instance, if the user sets the hash tag “#SummerBBQ_Story”, any message in a social messaging service that includes such tag may be identified by the story progression system, and then added to the story progression.

In a similar manner, the window 528 shows an example email collaboration option. An email address can be created that is specific to the particular story progression. Information sent to the email address may then be automatically added to the story progression or otherwise identified for possible inclusion. For instance, text and/or an image, video, audio file, and the like which is sent to the illustrated email address may be automatically included at a location in the story progression 502 (e.g., the end or another location). Alternatively, when media elements are provided to the email address, they may be provisionally included or simply identified so that the creator or another collaborator may potentially approve and/or place such elements. One or more collaborators may therefore curate the story.

Collaboration may also occur in other manners. For instance, the window 528 also includes a contributor link option. When the link is provided, the system can determine that the user has edit privileges. The user may then edit the story progression. In some embodiments, the link may provide full edit privileges, thereby allowing the user to add, move, resize, and even delete images or other media elements. In other embodiments, however, collaboration may be limited in some manner. As an example, the owner of a story progression may be the only person with the ability to delete elements. In other embodiments, different users of a system can potentially be identified and/or different access privileges can be assigned on a contributor-by-contributor basis. A full set of contribution and collaboration options may be provided. Indeed, in some embodiments, multiple users at remote locations or using different devices may even be able to collaborate in real-time in the creation, modification or distribution of a story progression. When the story progression system is administered by a website provider, login credentials and the like can also be associated with permissions for a specific story progression.

By authorizing others to edit or collaborate in the creation of the story progression, a story made from images, videos, and other elements can be given a true multi-dimensional perspective. For instance, if a story is created about the Olympics, one person may have visited some events and taken photographs at those events. The person may not, however, been able to visit all events. Thus, others can add their photographs to create a broader perspective of the entire event. The broader perspective may be provided by others that the creator allows to add to and contribute to the story progression, or potentially anyone by opening the story progression up to the public.

In another example, the Olympics may provide a world-wide perspective. Indeed, instead of posting images of the events and celebrations at the Olympics, different countries may have different celebrations or events going on there. Pictures taken in each of the different countries may be provided to provide a truly global view of what is happening when the Olympic events are underway. Images from Spain or Brazil, for example, may be uploaded and added to the story progression to show what each country had going on when a Brazil vs. Spain soccer match was in progress. Thus, rather than presenting a story from a single point of view, dozens or even hundreds of points of view can be combined into a story that uses photographs, drawings, text, video, audio, music, and the like. Moreover, with the intelligence system contemplated herein, such media elements can be intelligently added and arranged in relevant locations and orders to tell a cohesive story.

While embodiments of the present disclosure relate to story progressions as having a particular user who creates the story progression, it should also be appreciated that other embodiments may contemplate automatic creation of stories. For instance, the story progression system may monitor social networking websites to identify trending topics. Images, videos, audio files, text, or other media elements that relate to the trending topics may then be automatically added to a story progression that is created by the service itself. A world-wide story may then be created from publicly available information to give a narrative of the events happening and which are important at a particular time. Although not necessary, one embodiment contemplates monitoring hash tags of public social media and news sites, and creating story progressions from information and media posted and associated with particular tags (including hash tags).

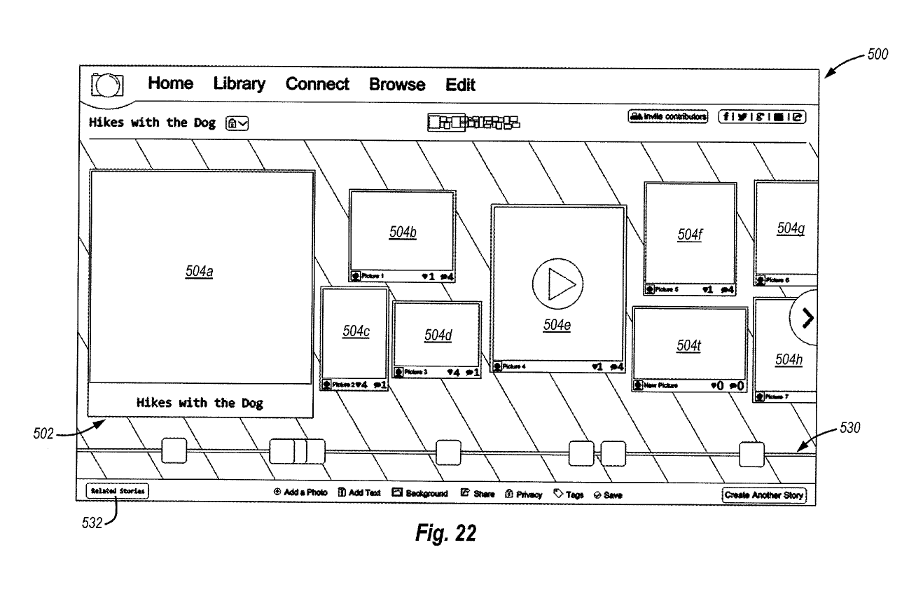

Still another aspect of some embodiments of the present disclosure is the ability to comment on story progressions, or portions thereof. Thus, a person may be able to add input even if not given access to contribute in a collaborative manner. As shown in FIG. 22, for instance, each of media elements 504b-504h, 504t may include information for interaction with viewers. The illustrated embodiment, for instance, includes a “Like” button (represented by a heart) for each media element 504b-504h, 504t. Such a button may allow users or guest viewers to indicate their approval or appreciation of the various elements of the story progression 502, and the number of approving viewers can be tracked. In other embodiments, viewers can potentially “Like” story progression as a whole 502. Indeed, as shown in FIG. 16, the number of viewers and those who have indicated they “Like” the story progression 502 can be tracked.

In addition to a “Like” or similar option, comments or other features may also be provided. FIG. 22 also illustrates a comment section (represented by a talking bubble). The images may show how many people have commented on a particular media element. Selecting the option may also allow viewers to view comments of others, or to contribute their own comments. Additionally, the various media elements 504a-504h, 504t may also be contributed by different people, in which case a different icon, description, or the like may provide information on the contributor. Media element 504t, for instance, may be provided by a different contributor than that for media elements 504a-504h.

Of course, rather than merely commenting on a particular image, viewers could also comment on the story progression 502 as a whole. Such comments may be added at the conclusion of the story progression 502, or in another manner. FIG. 22, for instance, illustrates an example where comments can be added at a spatially relevant location. In particular, the interface 500 may include a comment area 530, which is illustratively shown as a timeline extending across a length of the story progression 502. Instead of commenting on a particular media element, a viewer may select a location on the timeline. Such a location may correspond to where a particular series of events begin, where a particular perspective is represented, and the like. The comment can then be associated with that particular location. An icon or other indicator can be placed at that location to represent the comment. The creator or other viewers of the story progression 502 may then select the indicator to view who made the comment and what the comment says.

Another aspect of comments is that they may be used to show what parts of a story 502 seem to be drawing the most interest. By viewing which images have the most comments or “Like” selections, a viewer can see where interest is centered. Alternatively, if there is a timeline or other similar comment area 530 that allows spatially relevant comments, the viewer can see where groups or comments are located to have a visual representation of the popularity of a certain portion of the story.

An interface 500 used in creating, viewing and/or editing a story progression 502 may also include still other features. As shown in FIG. 22, for instance, a button, link, or other option 532 may allow a user to view related stories. One aspect of the present disclosure is that while a set of media elements may be arranged to tell a single story, a person often may have different stories they want to tell; however, the stories may be related. For instance, continuing the example of the Olympics, one story may be created to show a user's experience at the opening ceremonies. Another story may show the experience of the user at a tennis match or track and field event. Each story may be different, but related to the overall theme of the Olympics.

In a sense, each related story may be considered a chapter of an overall, greater experience or theme. Thus, a similar option may be to provide a link to view additional chapters (see FIG. 16). A creator of the story progressions may identify those that are related. For instance, one option is to use keywords or tags. An option to add tags is shown in the option list 514 of in FIG. 16. Of course, related stories may be identified in other manners. By way of example, a tree-structure can be set-up by the user or the system to identify related stories (e.g., parent-child story relationships, sibling story relationships, etc.). Indeed, there may even be a main or parent story that can then break into different sub-stories or chapters. Another example contemplates identifying different stories that share common images. Selecting the related stories option 532 may allow a viewer to see other stories that share common images.

Further, while chapters or related stories may be produced by the same content provider or creator, other embodiments contemplate using the related stories option 532 to access story progressions of others. Hundreds or thousands of content providers may create stories about the Olympics, for instance. By searching for other stories having a tag of “Olympics”, many other chapters or related stories can be identified, even if the content providers don't know each other.

FIGS. 4-22 generally illustrate example interfaces and embody systems in which a user may access, view, modify or otherwise interact with a story progression through a browser or similar application on the user's own computing device. Access may then be granted to stories that are stored locally on that device, or at a remote location (e.g., a server, a different device, etc.). In other embodiments, however, the browser may be replaced or supplemented by a specific application. As an example, so-called “mobile apps” may be developed for smartphones, personal media players, tablet computing devices, and the like. Such an application may be provided to allow viewers to use, browse, modify, etc. story progressions stored remotely or in a cloud, or stored on the device itself. Such interaction is not, however, limited to mobile devices and any computing device could have an application running locally to provide similar capabilities.

Described above are systems and method for creating and sharing stories that are based on images, videos, and other elements. Throughout the description, for the purposes of explanation, numerous specific details are set forth in order to provide a thorough understanding of the present disclosure. It will be apparent, however, to one skilled in the art that the present disclosure may be practiced without some of these specific details, or that other details may be provided. For instance, while the illustrated embodiments show story progressions that progress in a linear manner, from left-to-right, other visual formats may be used. A story may progress from right-to-left, from top-to-bottom, or the like. A story may also not be fully linear as the story may arc, have branches, loop, or otherwise be visually structured.

As a further illustration, while embodiments disclosed herein generally relate to a story progression allowing a user to progress at his or her leisure by selecting when to scroll, other embodiments contemplate a more automated process. For instance, an auto-playback option may be provided and selected by a viewer, content provider/story creator, or other party. Using such an option, the story progression may advance at a predetermined rate without a need for a user to manually scroll through the story progression. Such an option may be particularly desirable where, for instance, audio (e.g., music, narrative, voiceover, etc.) are provided to narrate or otherwise add interest to the story progression.

Embodiments of the present disclosure may generally be performed or implemented in one or more computing devices and systems, and more particularly performed in response to instructions provided by an application executed by the computing system. Embodiments of the present disclosure may thus comprise or utilize a special purpose or general-purpose computer including computer hardware, such as, for example, one or more processors and system memory, as discussed in greater detail herein. Embodiments within the scope of the present disclosure also include physical and other computer-readable media for carrying or storing computer-executable instructions and/or data structures, including applications, tables, or other modules used to execute particular functions or direct selection or execution of other modules. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the disclosure can comprise at least two distinctly different kinds of computer-readable media, including at least computer storage media and/or transmission media. Computer-readable media including computer-executable instructions may also be referred to as a computer-program product.

Examples of computer storage media include RAM, ROM, EEPROM, CD-ROM or other optical disk storage, magnetic disk storage or other magnetic storage devices, or any other non-transmission medium which can be used to store desired program code means in the form of computer-executable instructions or data structures and which can be accessed by a general purpose or special purpose computer.

A “network” may generally be defined as one or more data links that enable the transport of electronic data between computer systems and/or modules, engines, and/or other electronic devices. When information is transferred or provided over a communication network or another communications connection (either hardwired, wireless, or a combination of hardwired or wireless) to a computing device, the computing device properly views the connection as a transmission medium. Transmissions media can include a communication network and/or data links, carrier waves, wireless signals, and the like, which can be used to carry desired program or template code means or instructions in the form of computer-executable instructions or data structures and which can be accessed by a general purpose or special purpose computer. Combinations of physical storage media and transmission media should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above, nor performance of the described acts or steps by the components described above. Rather, the described features and acts are disclosed as example forms of implementing the claims.

Those skilled in the art will appreciate that the embodiments may be practiced in network computing environments with many types of computer system configurations, including, personal computers, desktop computers, laptop computers, message processors, hand-held devices, programmable logic machines, multi-processor systems, microprocessor-based or programmable consumer electronics, network PCs, tablet computing devices, minicomputers, mainframe computers, mobile telephones, PDAs, servers, and the like.

Embodiments may also be practiced in distributed system environments where local and remote computer systems, which are linked (either by hardwired data links, wireless data links, or by a combination of hardwired and wireless data links) through a network, both perform tasks. In a distributed computing environment, program modules may be located in both local and remote volatile and/or nonvolatile storage devices.

Throughout the foregoing description, for the purposes of explanation, numerous specific details were set forth in order to provide a thorough understanding of the aspects of the disclosure, although embodiments may be practiced without some of these specific details. For example, it will be readily apparent to those of skill in the art that the functional modules may be implemented as software, hardware or any combination thereof. Accordingly, the scope and spirit of the present disclosure should be judged in terms of the claims which follow.

What is claimed is:

1. A method for creating a story from a collection of media elements, comprising:
identifying a plurality of media elements to be incorporated into a story progression; and
generating the story progression, wherein generating the story progression includes:
determining an order for the plurality of media elements; and
arranging the plurality of media elements according to the determined order, such that the plurality of media elements are positioned in a continuous, visual arrangement that tells a cohesive story.

2. The method recited in claim 1, further comprising:
sharing the generated story progression with one or more third parties.

3. The method recited in claim 2, wherein sharing the generated story progression includes one or more of:
making the story progression available to the public;
identifying specific third parties to whom the story progression is available; or
sharing the story progression via a social media provider system.

4. The method recited in claim 1, further comprising:
inviting one or more third parties to contribute to the story progression.

5. The method recited in claim 1, further comprising:
automatically adding to the story progression by adding one or more additional media elements. wherein the one or more additional media elements are added from e

6. The method recited in claim 5, wherein the one or more additional media elements are received from:
a creator of the story progression;
a third party invited to contribute to the story progression; or
a public source.

7. The method recited in claim 5, wherein the one or more additional media are accessed by using:
an email address specific to the story progression;
a tag associated with the story progression;
upload from a client computing device; or
upload from a cloud computing network.

8. The method recited in claim 1, wherein the plurality of media elements include multiple different types of media elements.

9. The method recited in claim 1, wherein the plurality of media elements include a combination of one or more of:
images;
audio;
video;
text; or
advertisement.

10. The method recited in claim 1, wherein determining an order and arranging the media elements are performed automatically, the method further comprising:
modifying the position or size of one or more of the media elements in response to user input.

11. The method recited in claim 1, wherein determining an order for the plurality of media elements includes determining a logical flow for the plurality of media elements.

12. The method recited in claim 11, wherein determining the order for the plurality of media elements includes identifying one or more of:
creation date/time of the media elements;
content of the media elements;
location of the media elements; or
contributor of the media elements.

13. The method recited in claim 1, wherein arranging the plurality of media elements includes:
creating a mosaic pattern of media elements; and
factoring in a reduction of white space.

14. A method for distributing a story formed as a sequence of media elements, the method comprising:
accessing a story progression created by a first user, wherein the story progression includes a narrative formed as a sequential and continuous arrangement of media elements that collectively tell the narrative in a single digital canvas; and
sharing the story progression to one or more third parties, wherein sharing the story progression includes providing the one or more third parties with access to view the sequential and continuous arrangement of media elements to view the narrative depicted by the story progression.

15. The method recited in claim 14, wherein sharing the story progression includes sharing the story progression via one or more of social media or email.

16. The method recited in claim 14, wherein the story progression includes all media elements in a mosaic view without pagination, folders, or albums.

17. The method recited in claim 14, comprising:
receiving input from a second user to contribute to the story progression; and
when the second user has suitable permissions or the story progression is public, modifying the story progression based on the input from the second user to collaborate with the first user in developing the story of the story progression.

18. The method recited in claim 14, wherein sharing the story progression is authorized by the first user via a browser or mobile application interface.

19. The method recited in claim 18, wherein the story progression is a first story progression, the method further comprising:
identifying a second story progression;
determining that the first story progression is related to the second story progression; and
associating the first and second story progressions as related stories or chapters.

20. The method recited in claim 19, wherein determining that the first story progression is related to the second story progression includes determining that the first and second story progressions share:
a creator;
a contributor;
content;
theme; or
a tag.

21. A story progression creation system, comprising:
one or more processors;
computer-readable media or a communication link, wherein through the computer-readable media or the communication link the one or more processors have access to a set of instructions for implementing the method of claim 1.
